(19) United States
(12) Patent Application Publication
(10) Pub. No.: US 2016/0034995 A1
(43) Pub. Date: Feb. 4, 2016

(54) METHOD AND SYSTEM FOR AUTOMATED INDENTIFICATION AND ENGAGEMENT OF SERVICE PROVIDERS

(71) Applicant: SERVICE LABS, INC., Seattle, WA (US)

(72) Inventors: Matthew Todd Williams, Seattle, WA (US); Rajalakshmi Iyer Subramanian, Tamil Nadu (IN); Troy Kenneth Fendall, Seattle, WA (US); Eric Chandler Wilson, Seattle, WA (US); Gregor Neal Purdy, Mercer Island, WA (US); Amandeep Singh, Tamilnadu (IN); Mahul Hirnat Shah, Tamilnadu (IN); Dean Richard Falconer, Seattle, WA (US); Marjory Elizabeth Reiter, Seattle, WA (US)

(73) Assignee: SERVICE LABS, INC., Seattle, WA (US)

(21) Appl. No.: 14/875,915

(22) Filed: Oct. 6, 2015

Related U.S. Application Data
(63) Continuation-in-part of application No. 14/547,458, filed on Nov. 19, 2014.
(60) Provisional application No. 61/906,036, filed on Nov. 19, 2013.

(51) Int. Cl. G06Q 30/06

(52) U.S. Cl. CPC G06Q 30/0617

(57) ABSTRACT

The current document is directed to methods and systems that identify projects for which service consumers desire service provision and identify available candidate service providers that best match various project parameters and service-provision criteria determined by the automated system. Information describing the identified candidate service providers is presented to the service consumers by the systems to allow service consumers in order to facilitate their selection of service providers and scheduling of service provision. In one described implementation, service providers are matched to stock-keeping-unit (“SKU”) identifiers and location or locations. Service providers identified in the initial SKU-and-location-based matching process are then scored and ranked according to additional criteria and constraints, with information describing the highest-ranked service candidate providers provided to service consumers for selection and scheduling.

### CROSS-REFERENCE TO RELATED APPLICATIONS

This application is a continuation-in-part of U.S. application Ser. No. 14/547,458, filed Nov. 19, 2014, which claims the benefit of Provisional Application No. 61/906,036, filed Nov. 19, 2013.

### TECHNICAL FIELD

The current document is directed to automated methods for matching service providers to service consumers and, in particular, to a distributed computer system, and methods incorporated within the distributed computer system, that provides an automated service for identifying service needs of service consumers, identifying service providers able to provide needed services to service consumers, scheduling service provision, and monitoring service provision.

### BACKGROUND

During the past 20 years, advancements in computing, data-storage, and networking technologies along with the development and widespread adoption of the World Wide Web have together spawned Internet-based retailing, or e-commerce, which has revolutionized marketing and retailing of products throughout the world. Although online shopping systems were first developed in the late 1970s and online retailing appeared in the early 1980s, e-commerce began to emerge as a serious alternative to traditional marketing and retailing in the mid 1990s. Prior to the emergence of e-commerce, the vast majority of retail sales were conducted in physical commercial retail establishments and by catalog-based mail-order and telephone sales. During the past 20 years, e-commerce has grown to rival traditional retailing in many areas and has overtaken traditional retailing in particular areas, including the sales of books, recorded music, entertainment tickets, and software products. It is likely that Internet-based retailing will continue to expand and further displace traditional retailing methods in coming decades.

While retailing and marketing of products represents a major arena of economic activity, retailing and marketing of services performed by various types of service providers, including individual service providers and contractors, service-oriented businesses, and various types of service-providing organizations, represents another major and increasingly important arena of economic activity. Services range from local, personal services, including lawn care, home repair, painting, and appliance repair, to services provided by individuals to organizations, such as contract-based typing and data entry, software development, and market analysis, to complex services provided to individuals and organization, including various types of professional services, information-technology services, and other such complex services, and finally to services provided by organizations and professionals, including car repair, medical services, and legal services. Unlike retailing of products, the service sector has not yet been transformed by Internet-based retailing and marketing. Internet-based retailing of services has not reached sales volumes and consumer-acceptance levels comparable to those of Internet-based product retailing. Internet-based retailing of services to service consumers therefore represents a large, as yet largely untapped area of commerce, for which new types of systems and infrastructure will continue to be sought by those attempting to apply modern technologies to service provision.

### SUMMARY

The current document is directed to methods incorporated within an automated system that identifies projects for which service consumers desire service provision and that identifies available candidate service providers that best match various project parameters and service-provision criteria determined by the automated system in order to steer automated identification and selection of candidate service providers. Information describing the identified candidate service providers is presented to the service consumers by the automated system to allow service consumers to select service providers and schedule service provision. In one described implementation, service providers are matched to stock-keeping-unit (“SKU”) identifiers corresponding to one or more projects as well as the location or locations in which services associated with the projects are to be carried out. Candidate service providers identified in the initial SKU-and-location-based matching process are then scored and ranked according to additional criteria and constraints, with information describing the highest-ranked candidate service providers provided to service consumers for selection and scheduling.

### BRIEF DESCRIPTION OF THE DRAWINGS

FIGS. 1A-L illustrate interaction between a service consumer and the currently disclosed automated system that determines projects for which service provision is desired by service consumers, matches service providers with projects to automatically create a set of candidate service providers, provides information about the candidate service providers to service consumers, and receives selections of service providers by service consumers for scheduling of service provision.

FIG. 2 provides a general architectural diagram for various types of computers.

FIG. 3 illustrates an Internet-connected distributed computer system.

FIG. 4 illustrates cloud computing. In the recently developed cloud-computing paradigm, computing cycles and data-storage facilities are provided to organizations and individuals by cloud-computing providers.

FIG. 5 illustrates generalized hardware and software components of a general-purpose computer system, such as a general-purpose computer system having an architecture similar to that shown in FIG. 1.

FIGS. 6A-B illustrate two types of virtual machine and virtual-machine execution environments.

FIG. 7 illustrates the architecture of one implementation of the currently disclosed automated system that matches service providers with server-consumer projects.

FIGS. 8A-C illustrate the types of data maintained within the automated system to provide for the service-consumer web interface that allows service consumers to create project lists and select service providers for carrying out projects in the project lists from sets of candidate service providers matched to the project lists by the automated system.

FIGS. 9A-D include control-flow diagrams that illustrate operation of the consumer-web-application servers (706 in FIG. 7).

FIG. 10 illustrates a match-processing routine that represents the service-provider matching process carried out by the automated system.

FIG. 11 illustrates the relational-database perspective on data storage.

FIG. 12 shows a pseudocode implementation of a routine “processInput” that processes certain of the input data (1004 in FIG. 10) that is input to the match-processing process (1002 in FIG. 10).

FIG. 13 shows four SQL commands that carry out initial selection of providers from the relational database that contains the relational-database tables discussed above with reference to FIGS. 8A-C and FIG. 11.

FIG. 14 shows a number of pseudocode constant declarations and a type declaration used in subsequent pseudocode descriptions of the remaining portion of the provider-matching process.

FIG. 15 provides pseudocode for a routine “scoreProviders” that computers scores for the initial set of candidate providers.

FIGS. 16-18 provide pseudocode implementations of the seven routines, called in the pseudocode block 1516 shown in FIG. 15 of the routine “scoreProviders,” that compute component scores subsequently added together to form the match score for a service provider.

FIGS. 19 and 20 provide control-flow diagrams that illustrate implementation of the processing routine that carries out the service-provider matching process discussed above with reference to FIGS. 11-18.

FIGS. 21A-B illustrate short-message-service (“SMS”) and multimedia-messaging-service (“MMS”) communications between smart-phone-using consumers and providers and the automated system that matches service providers with service consumers discussed above with reference to FIGS. 1-20.

FIGS. 22A-K illustrates one implementation of SMS-and-MMS-based communications within the automated service-provision brokerage (“ASB”).

FIGS. 23A-F illustrate a variety of the different MMS graphical cards that may be returned to service consumers and service providers by the ASB during information transactions and conversations conducted by the ASB with service consumers and service providers via SMS and MMS messaging.

FIGS. 24A-E provide pseudocode and corresponding JavaScript code to illustrate certain features and aspects of the MMS-card-generation process that is used, within the ASB, to generate MMS cards on the fly.

FIG. 25 shows a time-series diagram that illustrates data flow within one implementation of an ASB involved in sending, by a job manager, a project-list MMS card to a service consumer.

### DETAILED DESCRIPTION

The current document is directed to methods incorporated within an automated system that allows service consumers to identify suitable service providers and schedule service provision by the service providers. In a first subsection, below, an example interaction between a service consumer and the automated system is provided with reference to illustrations of web pages that are generated by the automated system and viewed by the service consumer during the interaction. In a second subsection, an overview of the automated system is provided. In a third subsection, a detailed discussion of the methods, incorporated within the automated system, that identify service providers for selection by service consumers is provided, along with illustrations, diagrams, and pseudo code. In a fourth subsection, short-message-service (“SMS”) and multimedia-messaging-service (“MMS”) communications between smart-phone-using consumers and providers and the automated system that matches service providers with service consumers is discussed.

### An Example Interaction Between a Service Consumer and an Automated System that Identifies Service Providers for Selection and Scheduling by Service Consumers

In the following discussion, the phrase “the automated system” is used to refer to a distributed computer system that implements automated methods for matching service providers to service consumers. The phrase “the automated system” encompasses many different implementations, one of which is disclosed, in detail, in a following subsection. The automated system is a complex, physical, distributed computer system that provides automated services, carries out automated transactions, and that collects and distributes information through physical communications systems. The automated services provided by the automated system cannot be provided manually or by other traditional, non-computational methods.

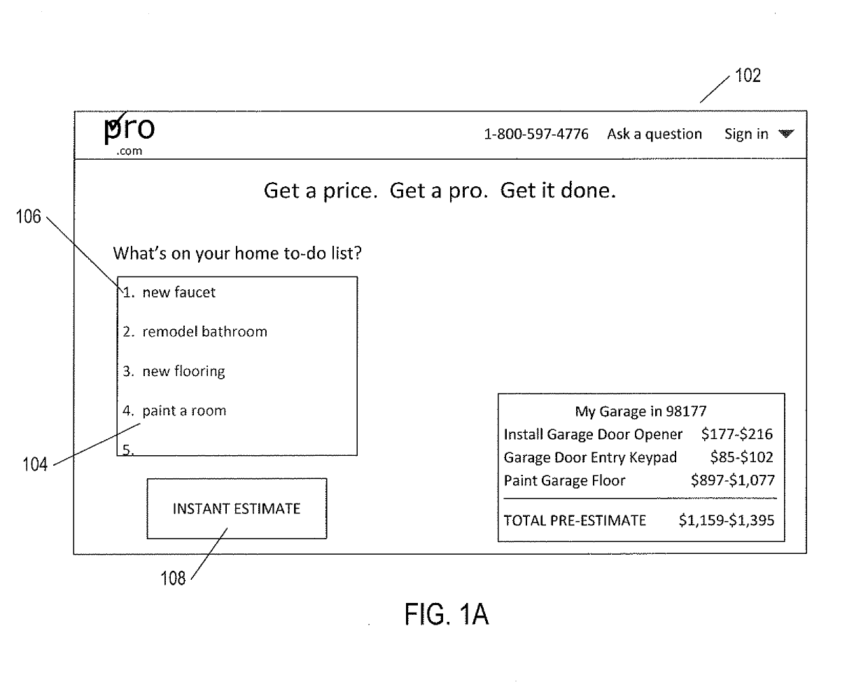

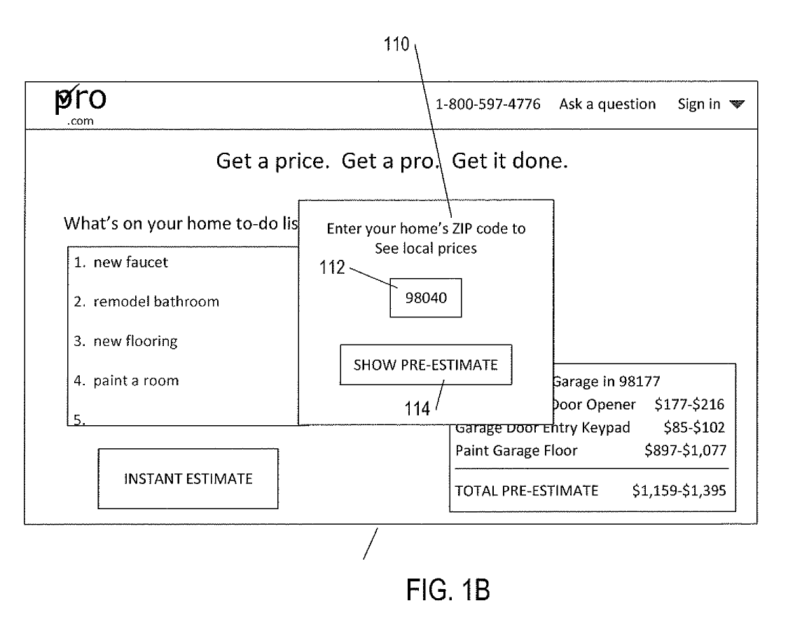

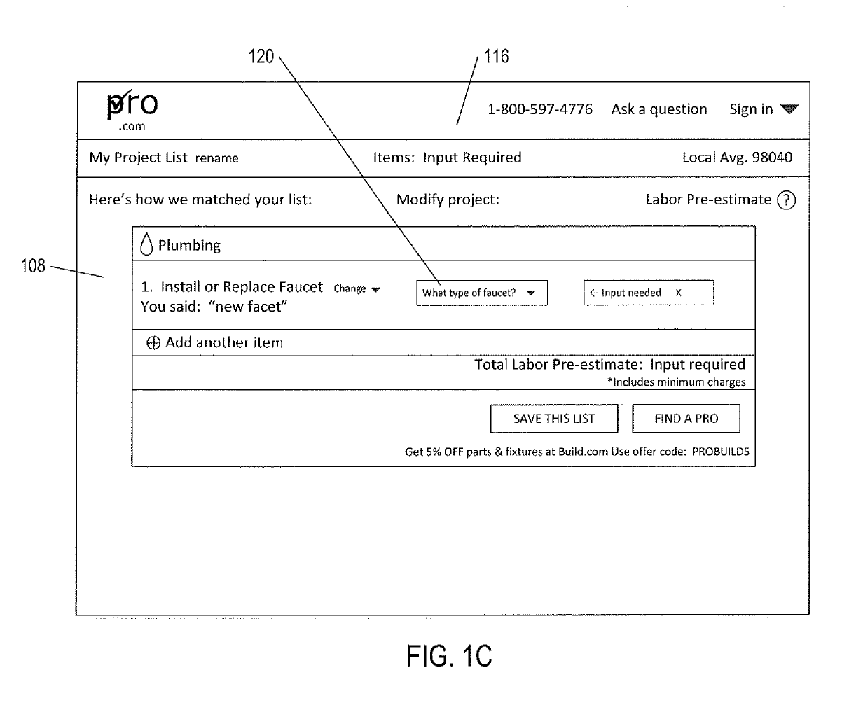

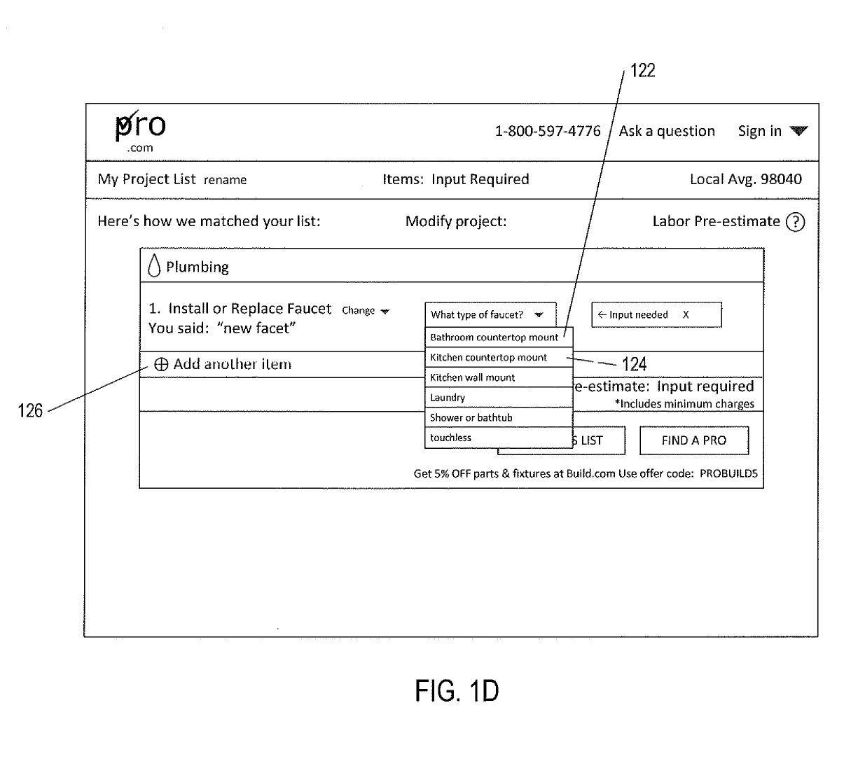

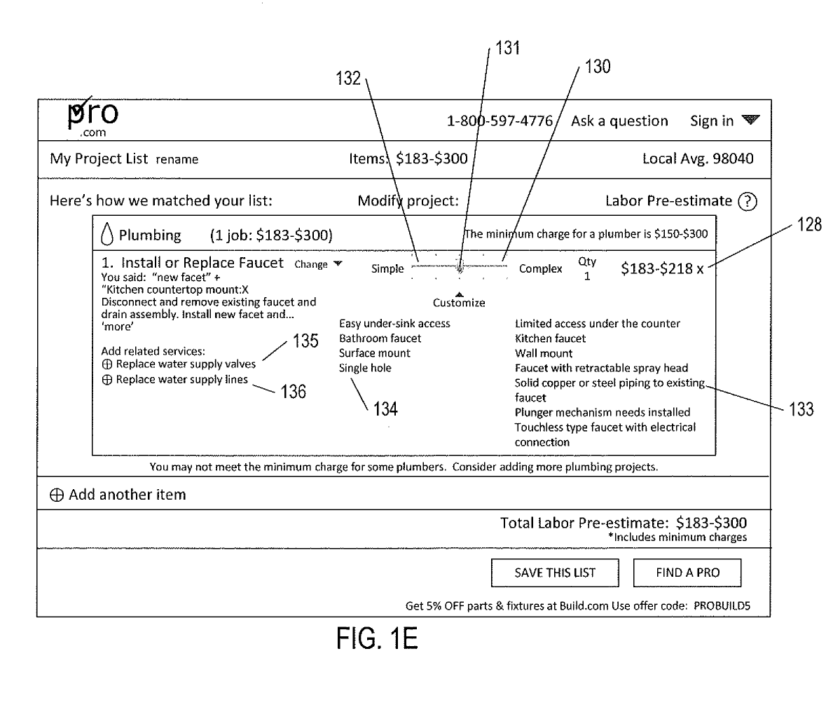

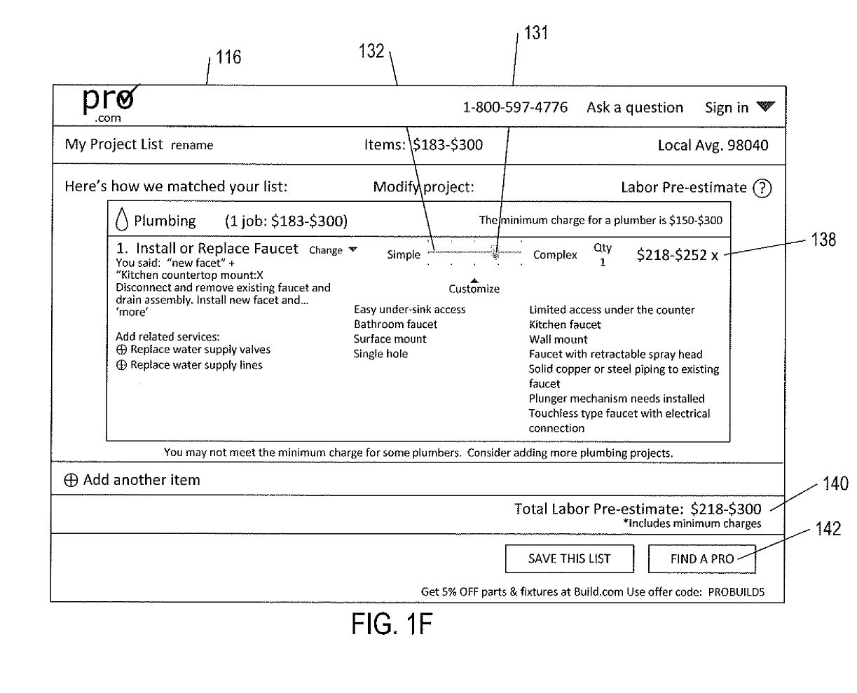

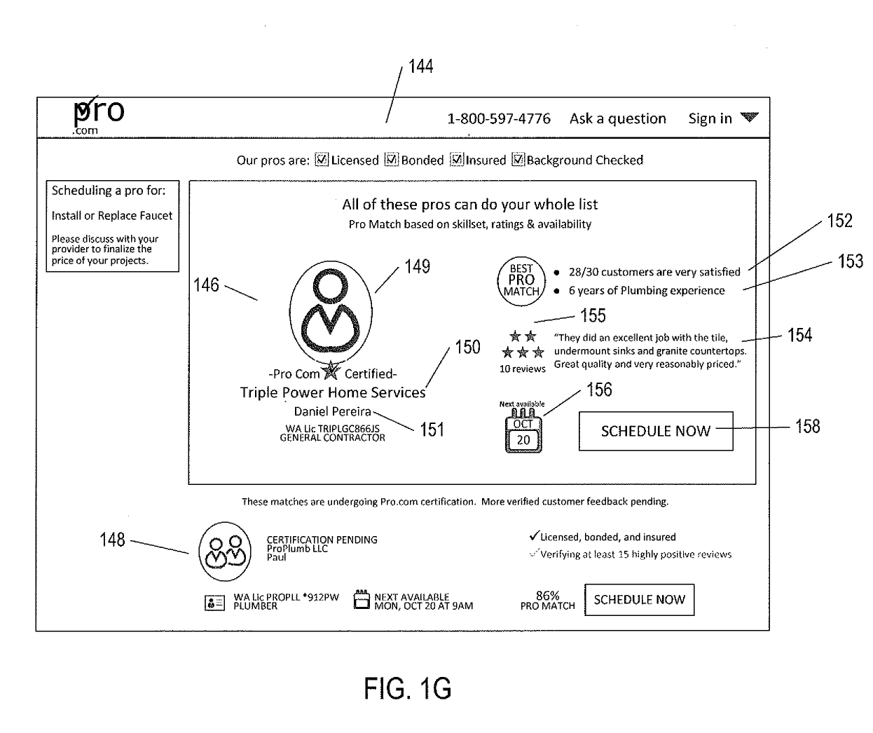

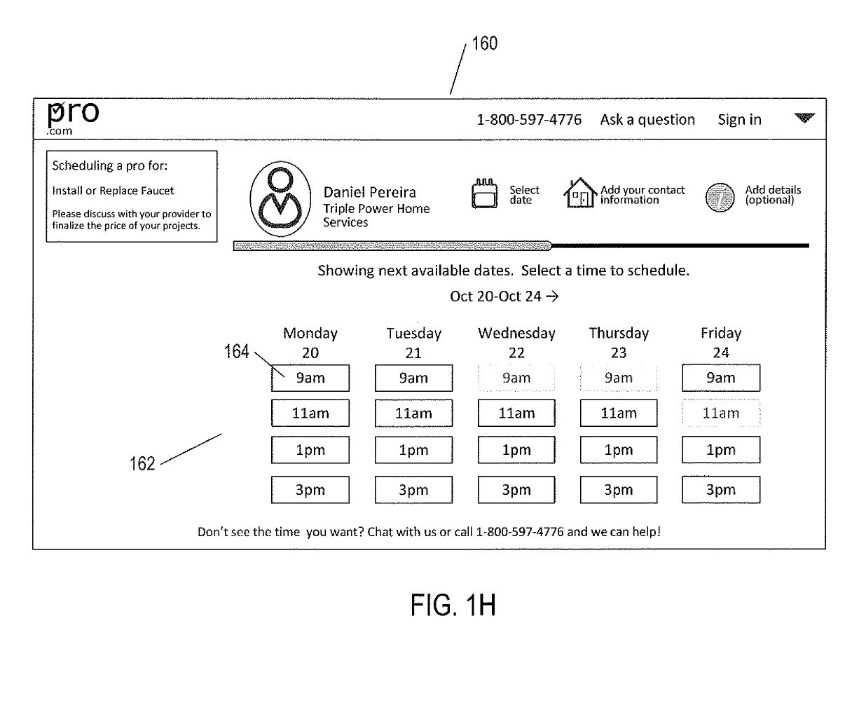

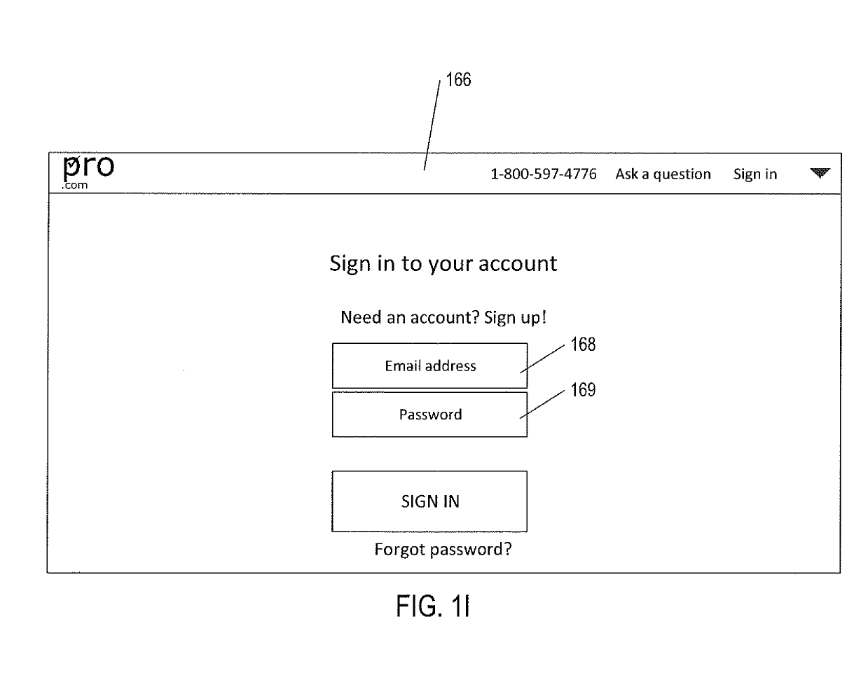

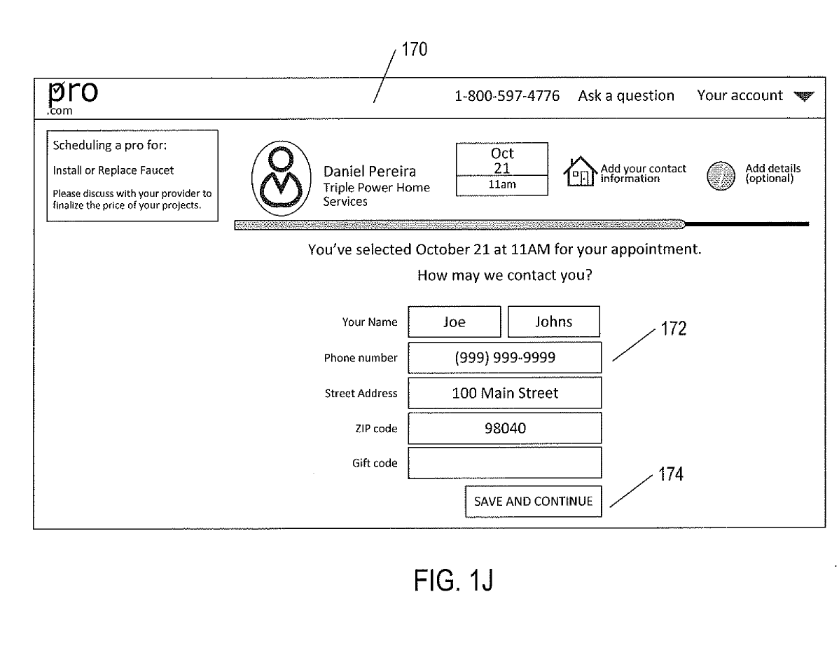

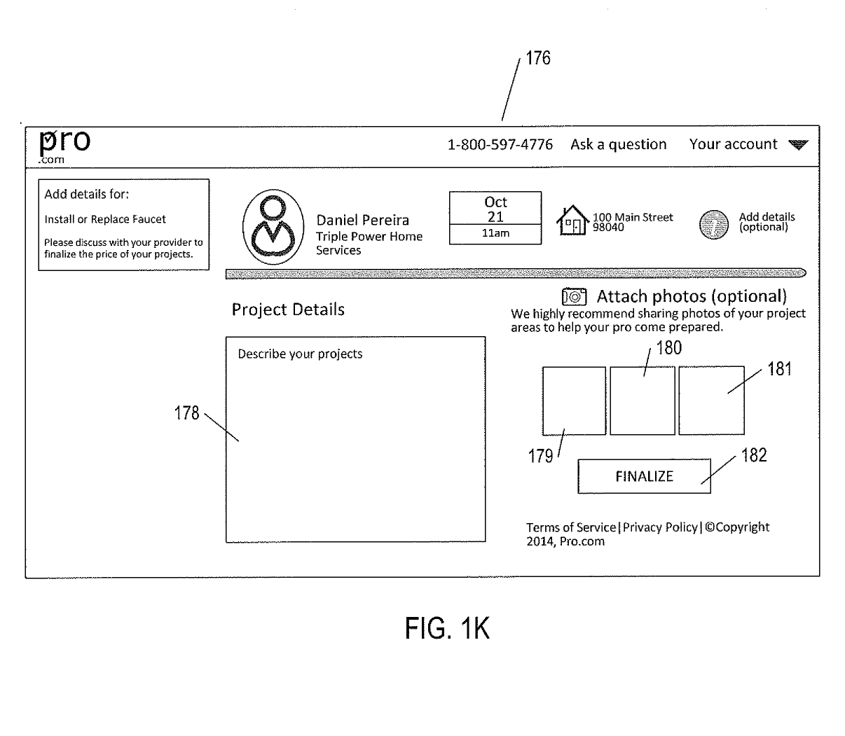

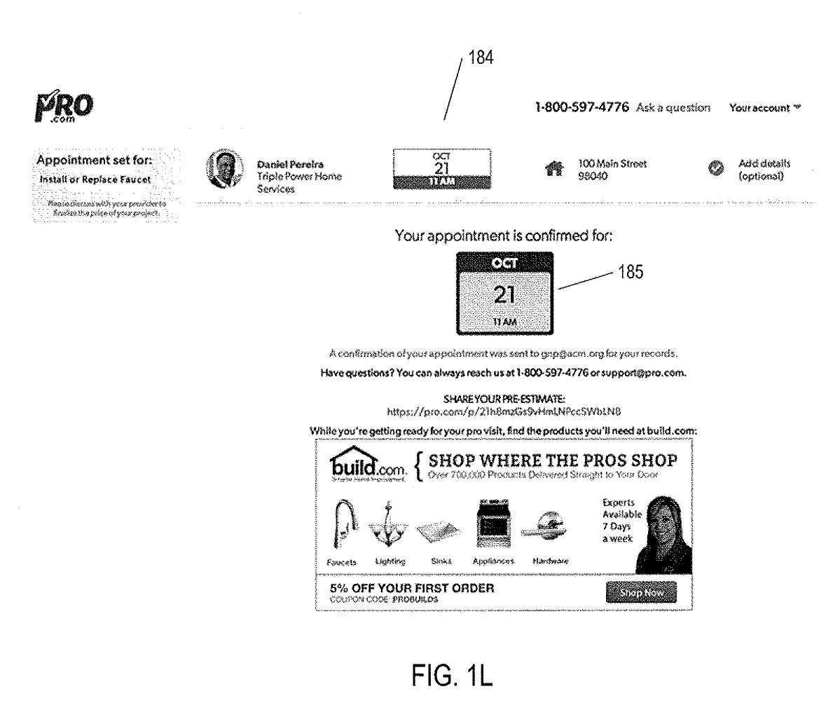

FIGS. 1A-L illustrate interaction between a service consumer and the currently disclosed automated system that determines projects for which service provision is desired by service consumers, matches service providers with projects to automatically create a set of candidate service providers, provides information about the candidate service providers to service consumers, and receives selections of service providers by service consumers for scheduling of service provision. The interaction between the service consumer and automated system is illustrated, in FIGS. 1A-L, with screen shots of web pages transmitted by the automated system to the service consumer's web browser for display to the service consumer on an electronic device, such as a personal computer, mobile phone, notebook, pad, or other Internet-connected electronic device. The service consumer initially accesses a home page provided by one or more web servers within the automated system via a browser bookmark, a link embedded within search-engine results, through hyperlinks included in various web-services aggregation pages, or by other familiar web-page-navigation methods.

FIG. 1A shows an initial web page 102 displayed to the service consumer by the service consumer's web browser. The initial web page provides a text-entry window 104 into which the service consumer may enter phrases that represent various projects for which the service consumer wishes to find and schedule a service provider. As shown in FIG. 1A, the service consumer has entered a project described by the phrase “new faucet” 106. The service consumer may enter an arbitrary number of project descriptions. Initial suggestions are displayed in the text-entry window in a faded text display to indicate the types of entries that can be made by the service consumer. When the service consumer has finished entering descriptions of projects for which the service consumer wishes to schedule a service provider, the service consumer inputs a mouse click to an “instant estimate” button 108. The mouse click directs the service consumer's browser to return the project list to the automated system and request a next interaction. In response, the automated system returns a pop-up request for the service consumer's zip code, shown in FIG. 1B. The pop-up zip-code request 110 includes a zip-code entry feature 112 into which the service consumer enters a zip code for the location where the one or more previously specified projects are to be carried out.

Following entry of the zip code, the service consumer inputs a mouse click to the “show pre-estimate” feature 114. Input of the mouse click to the “show pre-estimate” feature directs the service consumer's browser to return the zip code to the automated system. In response, the automated system returns a second web page to the service consumer's browser. FIG. 1C shows a screen shot of the second web page 116 displayed to the service consumer by the service consumer's browser. The second web page 116 displays an entry 118 for the new-faucet project previously described by the service consumer. The second web page displays an additional-information-request feature 120. When the service consumer inputs a mouse click to this additional-information-request feature 120, the service consumer's web browser returns a request for more information to the automated system which, in return, transmits a list of faucet types to the service consumer's web browser. The service consumer's web browser displays the returned list of faucet types in a drop-down information display 122 shown in FIG. 1D. Mouse-mediated selection of the “kitchen countertop mount” 124 by the service consumer results in the service consumer's web browser returning the kitchen-countertop-mount selection to the automated system. Note that, in the second web page 116 shown in FIGS. 1C-D, the service consumer may add additional projects via the “add another item” feature 126. In the current example, the service consumer is seeking only installation of a faucet and therefore does not input a mouse click to this feature.

FIG. 1E shows the second web page that has been modified in response to the service consumer's selection of the “kitchen countertop mount” entry 124 in the drop-down information display 122. The automated system has returned additional information that is now displayed for the faucet-replacement project. This information includes an initial price estimate 128 and a slider feature 130 that allows the user to indicate, by sliding a button 131 horizontally along a slider bar 132, the complexity of the faucet-replacement project. Characteristics and parameters that would indicate a more complex project are shown below the word “complex” 133 and characteristics and parameters that would indicate a more simple project 134 are displayed below the word “simple.” Additional-services features 135 and 136 allow the service consumer to request additional services related to the faucet-replacement project.

As shown in FIG. 1F, the service consumer has adjusted the slider button 131 rightward along the horizontal slider bar 132 to indicate more than average complexity, as a result of which, through an exchange of information with the automated system, the service consumer's web browser now displays a revised estimate 138 for the cost of having the project completed. Note also that a total pre-estimate 140 is displayed towards the bottom of the second web page 116. The total pre-estimate price includes additional charges that may result from a minimum charge required by potential service providers.

At this point in the interaction, with the project fully described, the service consumer may input a mouse click to the “find a pro” feature 142 to indicate a desire to review a list of one or more candidate service providers capable of carrying out the described project or projects. Input of the mouse click to the “find a pro” feature 142 directs the service consumer's browser to transmit a request to the automated system for a third web page that displays candidate service providers for the service consumer's project. FIG. 1G shows an example third web page returned by the automated system. The third web page 144 displays information about a highest-ranked service provider 146 who can repair or install faucets in the geographical location indicated for the project by the service consumer. When additional lower-ranked service providers are available, information about the additional candidate service providers 148 may also be displayed on the third web page. Information displayed regarding the highest-ranked candidate service provider includes a photograph 149, the name of the service provider's company 150, the name of the service provider 151, an indication of the reviews provided by previous customers of the service provider 152, an indication of the service provider's experience 153, text extracted from one of the favorable reviews 154, an indication of the average rating provided by reviewers 155, and the date of the next available appointment time 156 for the service provider. The displayed information may include hyperlinks to the full text of reviews provided by customers of the service provider.

When the service consumer inputs a mouse click to the “schedule now” input feature 158, the service consumer's web browser carries out an additional information exchange with the automated system in order to obtain appointment-time/schedule information for the service provider associated with the “schedule now” feature. The automated system returns a fourth web page, as shown in FIG. 1H. The fourth web page 160 provides a partial calendar 162 that lists upcoming available appointment times and already-booked appointment times for the selected service provider. The available appointment times are shaded, such as the shaded feature for the two-hour appointment time 164 beginning at 9:00 am on Monday, October 20^{th}. Input, by a service consumer, of a mouse click to an available appointment-time feature, such as feature 164, results in yet an additional information exchange with the automated system. In the current case, the automated system returns a fifth web page requesting the service consumer to log in to the service consumer's account or to set up a new account.

The fifth web page of the transaction is shown in FIG. 1I. Input of the service consumer's email address to input feature 168 of the fifth web page 166 and input of the service consumer's password to input feature 169 initiates an additional information exchange between the service consumer's web browser and the automated system, resulting in display of a modified fourth web page, shown in FIG. 1J, to the service consumer by the service consumer's web browser. The modified fourth web page 170 displays contact information 172, providing the service consumer with an opportunity to update this information, if necessary, and to then input a mouse click to the “save and continue” feature 174. This mouse-click input initiates yet an additional information exchange between the service consumer's web browser and the automated system, resulting in further modification and display of the fourth web page to the service consumer. The further-modified fourth web page 176 is shown in FIG. 1K. The further-modified web page includes a text-entry feature 178 and photo-input features 179-181 that allow the service consumer to provide additional textural information and photographic information to the automated system in order to further describe the service consumer's project or projects. Once the additional information has been provided, the service consumer inputs a mouse click to the “finalize” input feature 182, resulting in a final exchange of information between the service consumer's web browser and the automated system. As a result of the final information exchanged, a further modified fourth web page is displayed by the service consumer's web browser to the service consumer. FIG. 1L shows the finally modified fourth web page 184. The finally modified fourth web page displays the selected appointment time 186 and additional confirmation information. At this point, the automated system has scheduled service provision by the selected service provider and contacted the service provider by email, telephone, text message, and/or other communications means to schedule the service provision with the service provider. Information about the scheduled appointment is maintained within the automated system for subsequent access both by the service consumer and the service provider.

### Overview of the Distributed-Automated-System Architecture

In many discussions of computer-system architecture, the term “abstraction” is used to described higher-level entities relative to lower-level entities. The term “abstraction” is not, in any way, intended to mean or suggest an abstract idea or concept. Computational abstractions are tangible, physical interfaces, modules, and subsystems that are implemented, ultimately, using physical computer hardware, data-storage devices, and communications systems. The term “abstraction” refers, in computational fields, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces.

There is a tendency among those unfamiliar with modern technology and science to misinterpret the terms “abstract” and “abstraction,” when these terms are used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

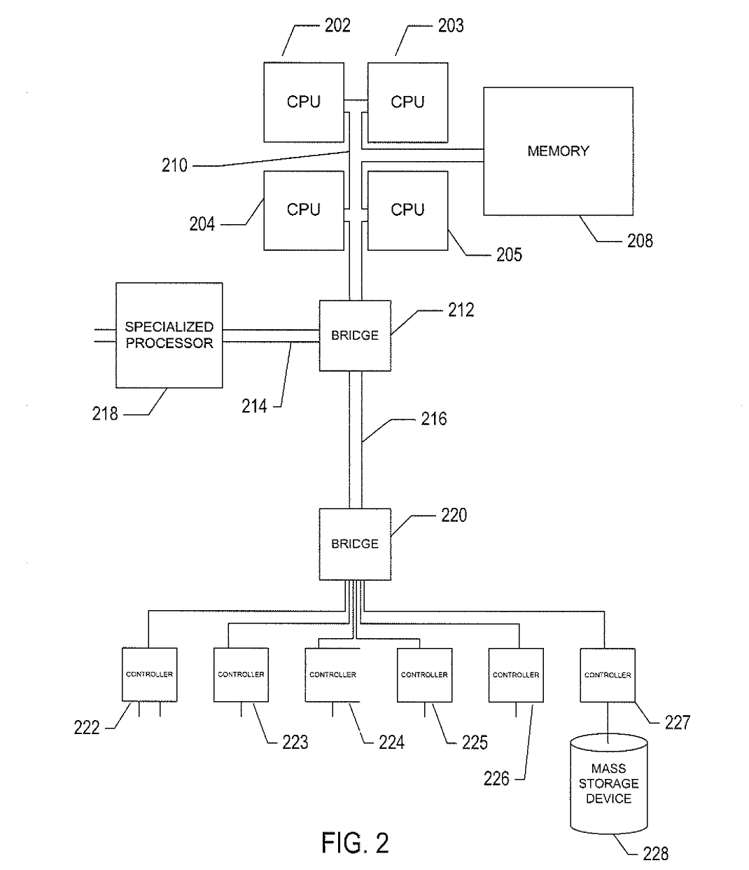

FIG. 2 provides a general architectural diagram for various types of computers. Computers within distributed systems that receive, process, and store data about service providers, service consumers, and services may be described by the general architectural diagram shown in FIG. 2, for example. The computer system contains one or multiple central processing units (“CPUs”) 202-205, one or more electronic memories 208 interconnected with the CPUs by a CPU/memory-subsystem bus 210 or multiple busses, a first bridge 212 that interconnects the CPU/memory-subsystem bus 210 with additional busses 214 and 216, or other types of high-speed interconnection media, including multiple, high-speed serial interconnects. These busses or serial interconnections, in turn, connect the CPUs and memory with specialized processors, such as a graphics processor 218, and with one or more additional bridges 220, which are interconnected with high-speed serial links or with multiple controllers 222-227, such as controller 227, that provide access to various different types of mass-storage devices 228, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

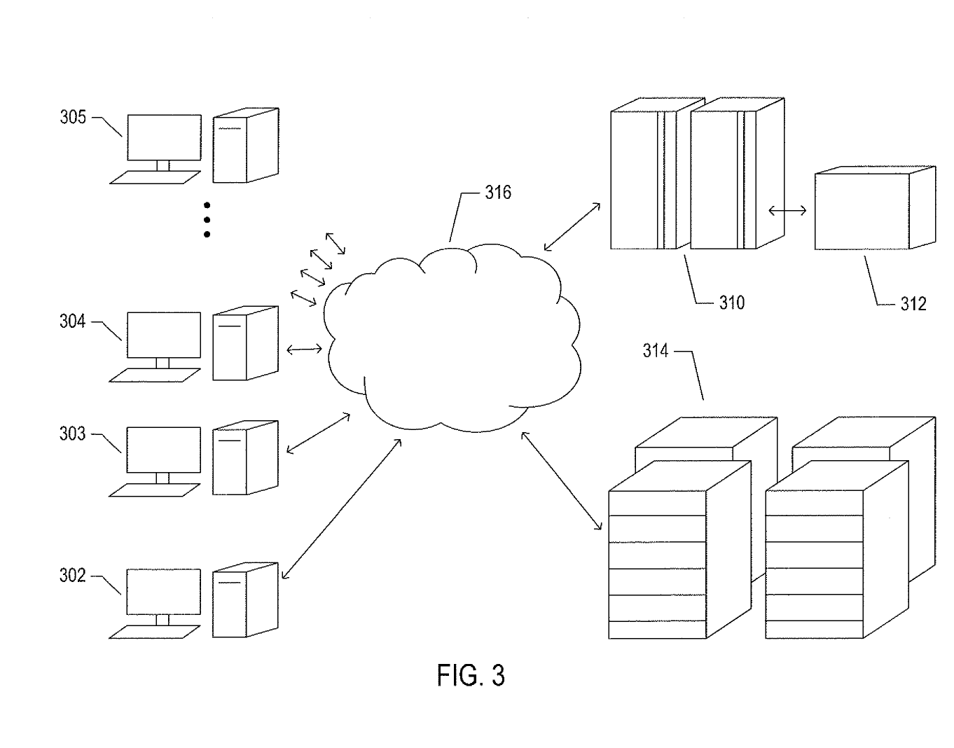

FIG. 3 illustrates an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 3 shows a typical distributed system in which a large number of PCs 302-305, a high-end distributed mainframe system 310 with a large data-storage system 312, and a large computer center 314 with large numbers of rack-mounted servers interconnected through various communications and networking systems that together comprise the Internet 316. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

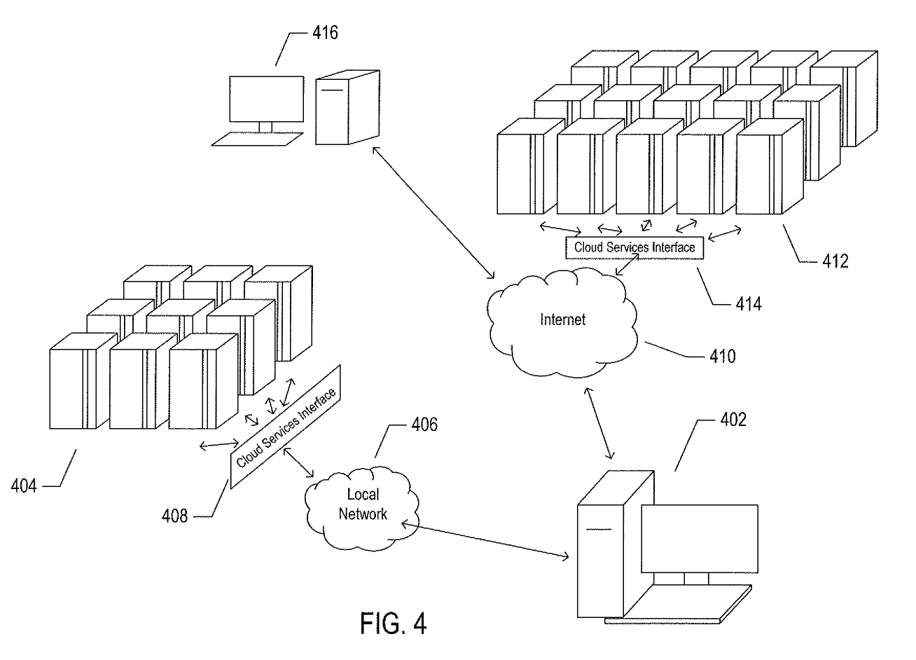

FIG. 4 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 4, a system administrator for an organization, using a PC 402, accesses the organization's private cloud 404 through a local network 406 and private-cloud interface 408 and also accesses, through the Internet 410, a public cloud 412 through a public-cloud services interface 414. The administrator can, in either the case of the private cloud 404 or public cloud 412, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 416:

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

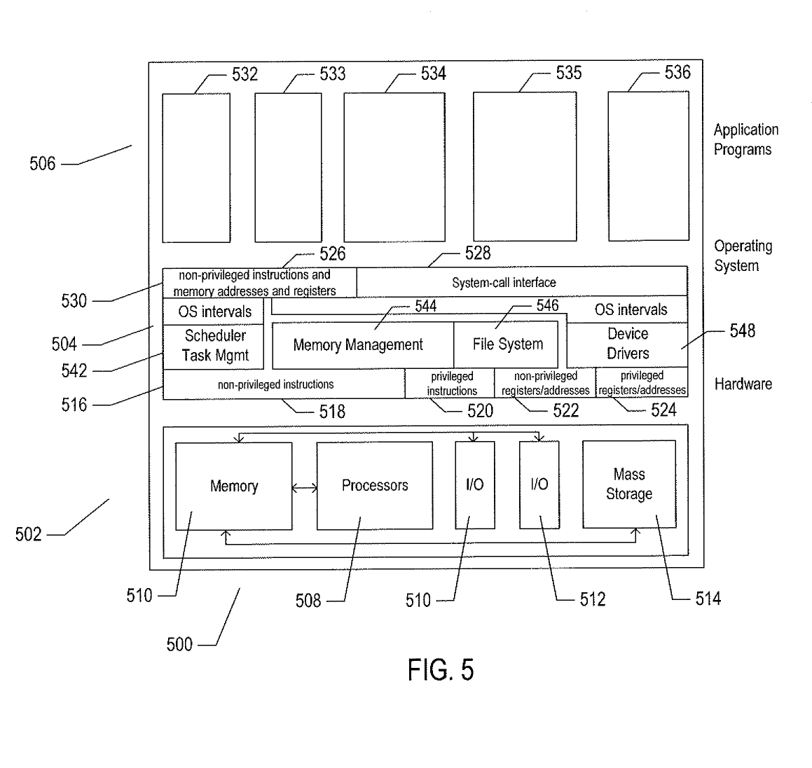

FIG. 5 illustrates generalized hardware and software components of a general-purpose computer system, such as a general-purpose computer system having an architecture similar to that shown in FIG. 5. The computer system 500 is often considered to include three fundamental layers: (1) a hardware layer or level 502; (2) an operating-system layer or level 504; and (3) an application-program layer or level 506. The hardware layer 502 includes one or more processors 508, system memory 510, various different types of input-output (“I/O”) devices 510 and 512, and mass-storage devices 514. Of course, the hardware level also includes many other components, including power supplies, internal communications links and busses, specialized integrated circuits, many different types of processor-controlled or microprocessor-controlled peripheral devices and controllers, and many other components. The operating system 504 interfaces to the hardware level 502 through a low-level operating system and hardware interface 516 generally comprising a set of non-privileged computer instructions 518, a set of privileged computer instructions 520, a set of non-privileged registers and memory addresses 522, and a set of privileged registers and memory addresses 524. In general, the operating system exposes non-privileged instructions, non-privileged registers, and non-privileged memory addresses 526 and a system-call interface 528 as an operating-system interface 530 to application programs 532-536 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 542, memory management 544, a file system 546, device drivers 548, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 536 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

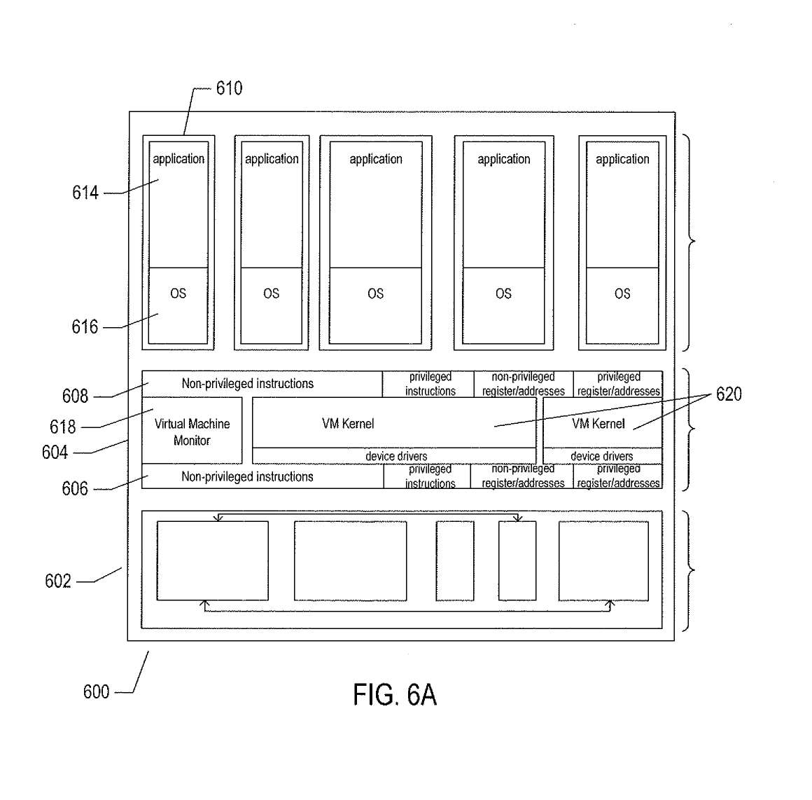

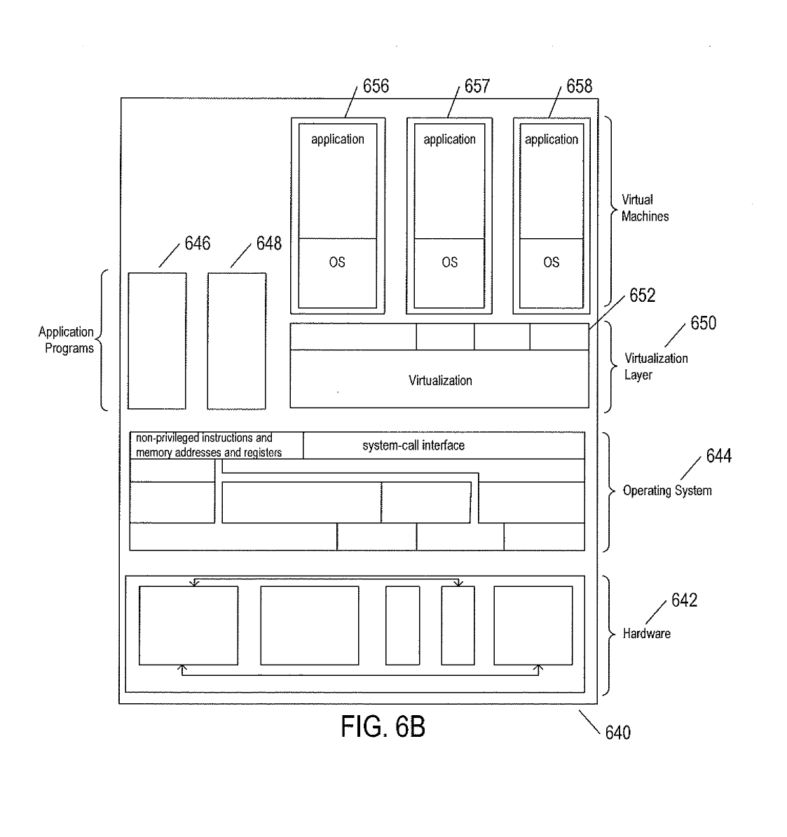

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 6A-B illustrate two types of virtual machine and virtual-machine execution environments. FIGS. 6A-B use the same illustration conventions as used in FIG. 5. FIG. 6A shows a first type of virtualization. The computer system 600 in FIG. 6A includes the same hardware layer 602 as the hardware layer 502 shown in FIG. 5. However, rather than providing an operating system layer directly above the hardware layer, as in FIG. 5, the virtualized computing environment illustrated in FIG. 6A features a virtualization layer 604 that interfaces through a virtualization-layer/hardware-layer interface 606, equivalent to interface 516 in FIG. 5, to the hardware. The virtualization layer provides a hardware-like interface 608 to a number of virtual machines, such as virtual machine 610, executing above the virtualization layer in a virtual-machine layer 612. Each virtual machine includes one or more application programs or other higher-level computational entities packaged together with an operating system, referred to as a “guest operating system,” such as application 614 and guest operating system 616 packaged together within virtual machine 610. Each virtual machine is thus equivalent to the operating-system layer 504 and application-program layer 506 in the general-purpose computer system shown in FIG. 5. Each guest operating system within a virtual machine interfaces to the virtualization-layer interface 608 rather than to the actual hardware interface 606. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 608 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 618 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 608, the accesses result in execution of virtualization-layer code to simulate or emulate the privileged resources. The virtualization layer additionally includes a kernel module 620 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 6B illustrates a second type of virtualization. In FIG. 6B, the computer system 640 includes the same hardware layer 642 and software layer 644 as the hardware layer 502 shown in FIG. 5. Several application programs 646 and 648 are shown running in the execution environment provided by the operating system. In addition, a virtualization layer 650 is also provided, in computer 640, but, unlike the virtualization layer 604 discussed with reference to FIG. 6A, virtualization layer 650 is layered above the operating system 644, referred to as the “host OS,” and uses the operating system interface to access operating-system-provided functionality as well as the hardware. The virtualization layer 650 comprises primarily a VMM and a hardware-like interface 652, similar to hardware-like interface 608 in FIG. 6A. The virtualization-layer/hardware-layer interface 652, equivalent to interface 516 in FIG. 5, provides an execution environment for a number of virtual machines 656-658, each including one or more application programs or other higher-level computational entities packaged together with a guest operating system.

In FIGS. 6A-B, the layers are somewhat simplified for clarity of illustration. For example, portions of the virtualization layer 650 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

Many implementations of the distributed service-provider-matching system, discussed in the following subsection, employ large numbers of virtual servers within virtual data centers provided by cloud-computing facilities. Other implementations may employ standalone servers and various types of private data centers. In all implementations, the distributed system consists of complex hardware platforms, various electronic user devices, and control components stored and executed within these hardware platforms and electronic user devices that, in part, comprise millions of electronically stored processor instructions.

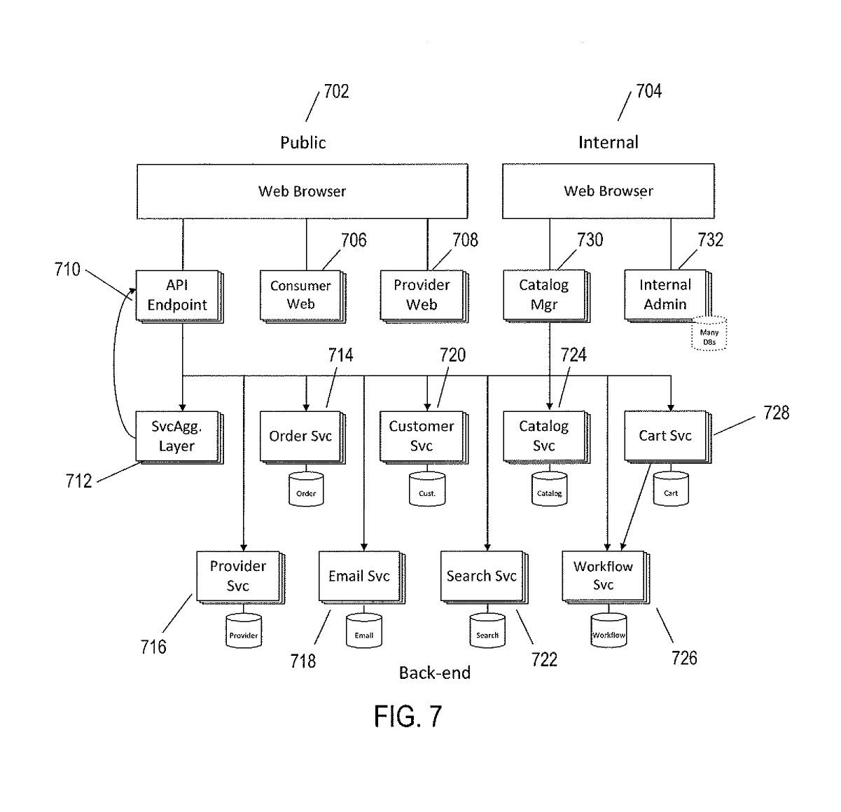

FIG. 7 illustrates the architecture of one implementation of the currently disclosed automated system that matches service providers with server-consumer projects. The architecture is illustrated in FIG. 7 as a block diagram. The automated system provides both a public interface 702 and an internal, private interface 704. The public interface is provided to remote web browsers by servers that run a consumer-web application 706 and servers that run a provider web application 708. In the currently described implementation, these servers, and additional servers running services, described below, reside in a distributed virtual data center provided by a cloud-computing-services organization.

The consumer-web application run by consumer-web servers 706 provides a web-page interface to service consumers that allow service consumers to create accounts, log into the automated system, create and edit project lists, obtain information about service providers matched to the project lists, select service providers, and schedule service provision by the selected service providers. An example web-page interface is discussed above with reference to FIGS. 1A-L.

The provider-web application, executed on multiple provider-web-application servers 708, provides a web-page interface to service providers. The service-provider web-page interface allows service providers to log into the automated system, create accounts, receive service-provision orders from service consumers, manage the orders, and carry out other interactions with the automated system. Both the consumer-web-application servers and provider-web-application servers access a large number of additional, internal servers and other computer systems that provide a number of services to the consumer-web-application servers and provider-web-application servers through API endpoint servers 710 that run an API-endpoint application. The API-endpoint-application servers 710 interact with aggregation-service servers 712, order-service servers 714, provider-service servers 716, email-service servers 718, customer-service servers 720, search-service servers 722, catalog-service servers 724, workflow-service servers 726, and cart-service servers 728 to provide complex services to the consumer-web-application servers and provider-web-application servers. The service-aggregation servers 712 run an aggregation service that aggregates data from other of the service servers to create complex data objects that are returned through the API-endpoint servers to requesting consumer-web-application servers and provider-web-application servers. The order service, implemented by the order-service servers 714, provides services related to recording and tracking orders made by service consumers as well as maintaining data regarding service providers' availability and schedules. The customer service provided by customer-service servers maintains service-consumer information, including name, contact information, address information, account information, credit information, and other service consumer information. The catalog service provided by the catalog-service server 724 maintains databases of SKUs, including price information, trade information, and skill information. The cart service provided by the cart-service servers 728 maintains project lists for service consumers as they are created and modified by service consumers prior to scheduling service provision. The provider service provided by the provider-service servers 716 maintains information about service providers, including name, years in business, contact information, and other such information. The match-processing functionality, discussed in detail in the following subsection, is executed by the provider-service servers. The email service provided by the email-service servers 718 maintains email-communications templates used for communicating with both service providers and service consumers. The search service provided by the search-service servers 722 maintains indexes of search terms that are mapped to SKUs maintained by the catalog service. The workflow service provided by the workflow-service servers 726 carries out offline processing of asynchronous workflows involved with order processing and system maintenance. The internal interface 704 includes an administrative web-page interface provided by catalog-manager-application servers 730 that allows employees of the organization that manages the automated system to modify information maintained and provided by the various service-providing servers. An additional internal-administration interface is provided by internal-administration servers 732.

In most implementations, there are multiple virtual servers of each type that are logically represented by a single endpoint. Load-balancing functionality is employed for distributing workload among the multiple servers of each service and interface. Internal communications, in many implementations, employ RESTful Representational state transfer protocols (“RESTful protocols”) based on JavaScript Object Notation (“JSON”) over the hypertext transfer protocol (“HTTP”). Each of the services is generally associated with stored information. In many implementations, the stored information is stored in various virtual mass-storage appliances for access by the service-providing services.

### Method and System for Matching Service Providers to Service Consumer Projects

In the current subsection, a detailed description of one implementation of the automated method for matching service providers to service consumer projects is provided with reference to descriptions of stored data, flow diagrams, and pseudo code. This information provides a detailed description of one implementation of the method for matching service providers to service consumer projects that is incorporated within implementations of the distributed automated system discussed in previous subsections.

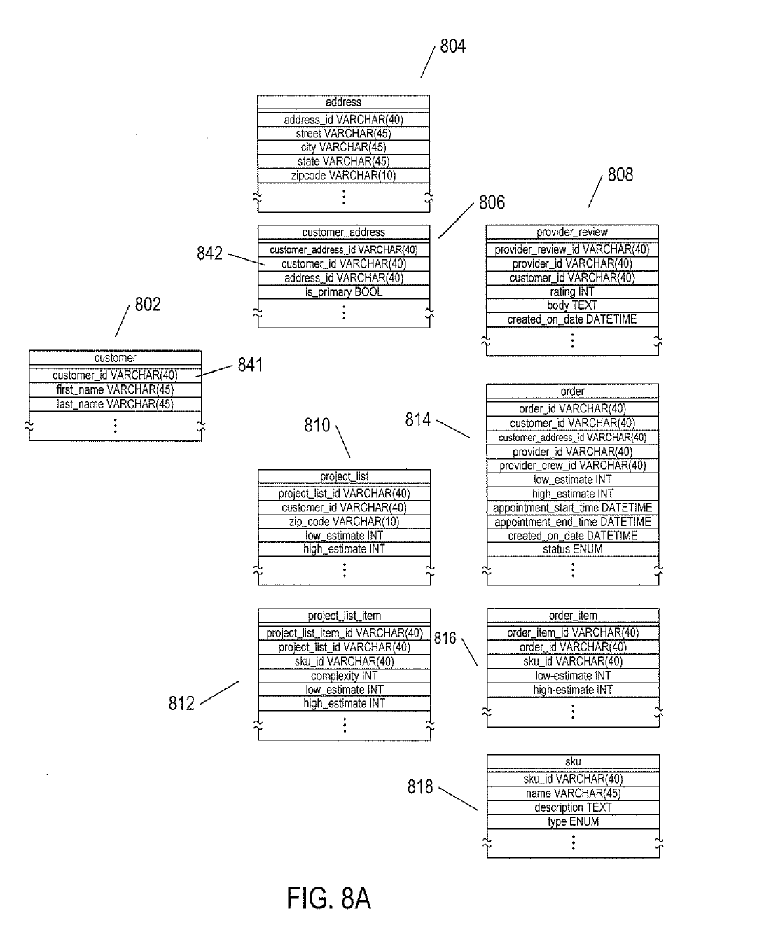

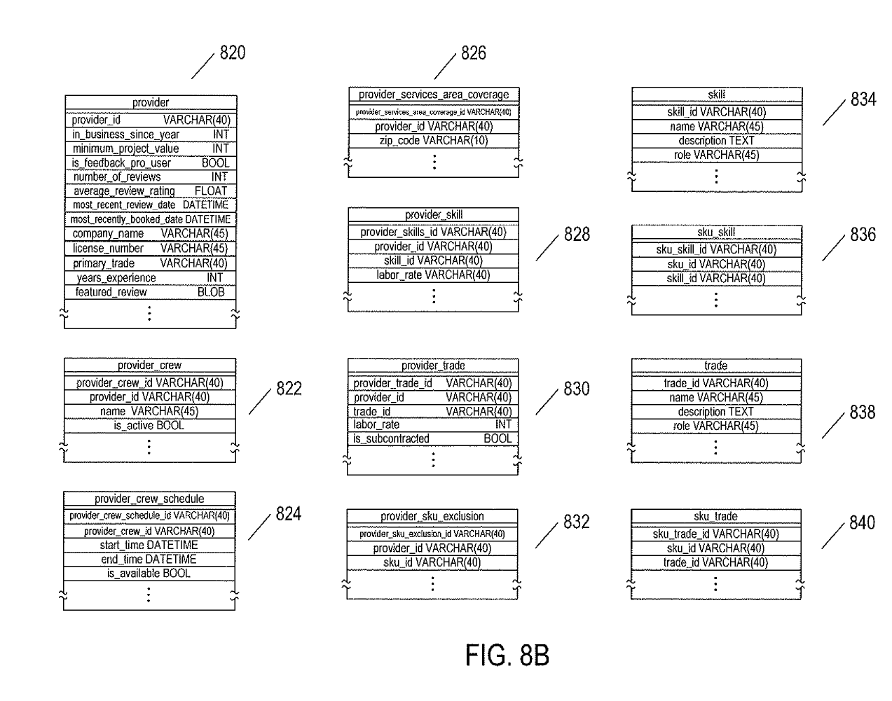

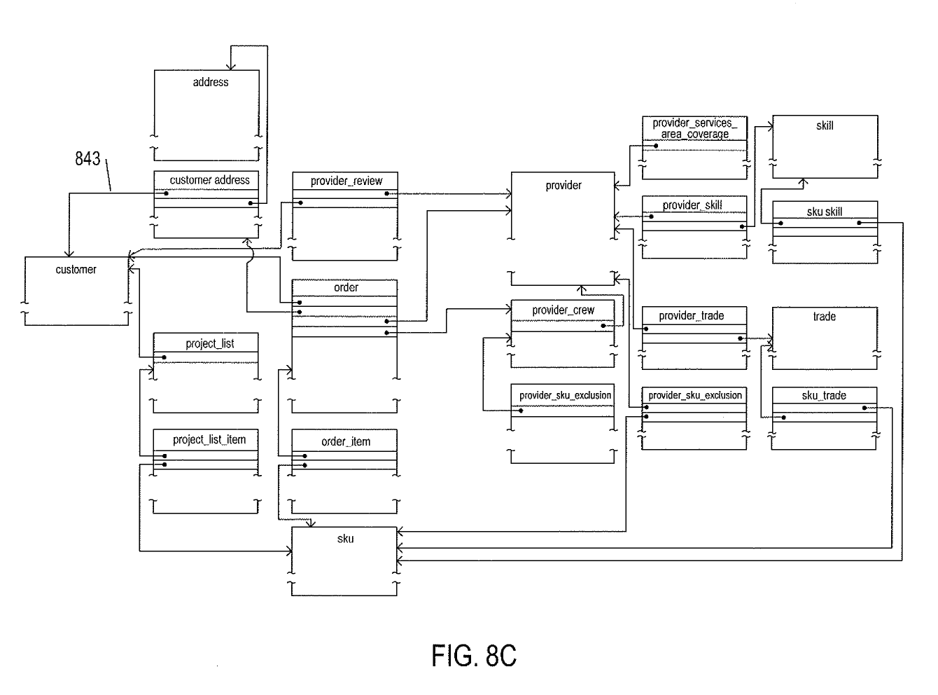

FIGS. 8A-C illustrate the types of data maintained within the automated system to provide for the service-consumer web interface that allows service consumers to create project lists and select service providers for carrying out projects from sets of candidate service providers matched to the project lists by the automated system. It should be emphasized that, in the distributed automated system, data may be distributed across multiple types of servers running different applications, with each server or type of server responsible for storing and managing only a portion of the aggregate data stored and managed by the distributed automated system. In the following discussion, the aggregate data is discussed as if it were stored in a single database or storage appliance. In certain implementations, this may be the case, but in many implementations, it is not the case. However, viewing the data as a whole, rather than as partitioned among server types, provides greater clarity and simplicity of description.

In FIGS. 8A-B, the stored data is organized into higher-level categories or data-object types. These higher-level categories include customer data 802, address data 804, customer-address data 806, provider-review data 808, project-list data 810, project-list-item data 812, order data 814, order-item data 816, and SKU data 818, as shown in FIG. 8A, and provider data 820, provider-crew data 822, provider-crew-schedule data 824, provider-services-area-coverage data 826, provider-skill data 828, provider-trade data 830, provider-SKU-exclusion data 832, skill data 834, SKU-skill data 836, trade data 838, and SKU-trade data 840, shown in FIG. 8B. Each of the data-object types shown in FIGS. 8A-B includes multiple fields, each field corresponding to a horizontal row or entry and including a field name and corresponding data type. The automated system generally stores many different data objects of each type. A data object is an instantiation of a data-object type, and includes specific values for each of the fields. A data-object type is a template or pattern for instantiating data objects of the data-object type.

Each data-object type includes a data-object-identifier field, the identifier within which uniquely identifies each data object instantiated from each data-object type shown in FIGS. 8A-B. For example, each customer, or service consumer, for which customer information is stored within the automated system is identified by a customer identifier, shown in FIG. 8A as the customer_id entry 841 in the customer data object 802. The customer_id entry, or field, has the data type “VARCHAR(40).” This data type is a variable length character string with a maximum size of 40 characters.

Many of the data-object types illustrated in FIGS. 8A-B include fields that contain identifiers, or keys, for linking data objects instantiated from these data-object types to other data objects. For example, a customer-address data object instantiated from the customer-address data-object type 806 includes a field 842 that contains the customer identifier of a customer data object that describes a customer whose address is represented by a customer-address data object. FIG. 8C illustrates links between data-object types. For example, the link from a customer-address data object to a customer data object is represented by arrow 843 in FIG. 8C.

In general, there are many objects of each data-object type stored in the automated system. For example, each service consumer is represented by a customer data object of the customer data-object type 802. Similarly, each service provider associated with the automated system is represented by a provider data object of the provider data-object type 820. A particular address may be used by multiple customers, as a result of which each customer-address data object references an address data object of the address data-object type 804, to avoid storage of redundant address information. Each customer project list is represented by a data object of the project-list data-object type 810. Projects within the list are represented by data objects of the project-list-item data-object type 812. Reviews of services provided for service providers by service consumers are represented by data objects of the provider-review data-object type 808. Orders for services, or scheduled appointments, are represented by data objects of the order data-object type 814. Individual scheduled tasks that together comprise an order are each represented by data objects of the order-item data-object type 816. The SKUs corresponding to various different types of services performed by the service providers associated with the automated system are each represented by an SKU data object of the SKU data-object type 818. Each member of a provider's crew is represented by a data object of the provider-crew data-object type 822. Each appointment time associated with a provider crew member is represented by a data object of the provider-crew-schedule data-object type 824. The service areas associated with a provider are each represented by a data object of the provider-services-area-coverage data-object type 826. Skills associated with a provider are each represented by a data object of provider-skill data-object type 828. Each trade associated with a provider is represented by a data object of the provider-trade data-object type 830. The SKUs describing services that cannot be performed by a provider are represented by data objects of the provider-SKU-exclusion data-object type 832. Skills are represented by data objects of the skill data-object type 834. Data objects of the SKU-skill data-object type 836 provide for association of provider-skill data objects with skill data objects. Each trade is represented by a data object of the trade data-object type 838. SKU-trade data objects of the SKU-trade data-object type 840 associate trade data objects with SKU data objects.

The names of the fields or entries within the data-object types shown in FIGS. 8A-B are largely self-descriptive. Particular field types used in the matching method are discussed below. As also discussed, below, the data-object types shown in FIGS. 8A-B may be implemented in a variety of different ways, including as instantiations of data-object classes stored within an object-oriented database, as relational-database tables, in flat-file-based data storage, and by many other types of data-storage systems.

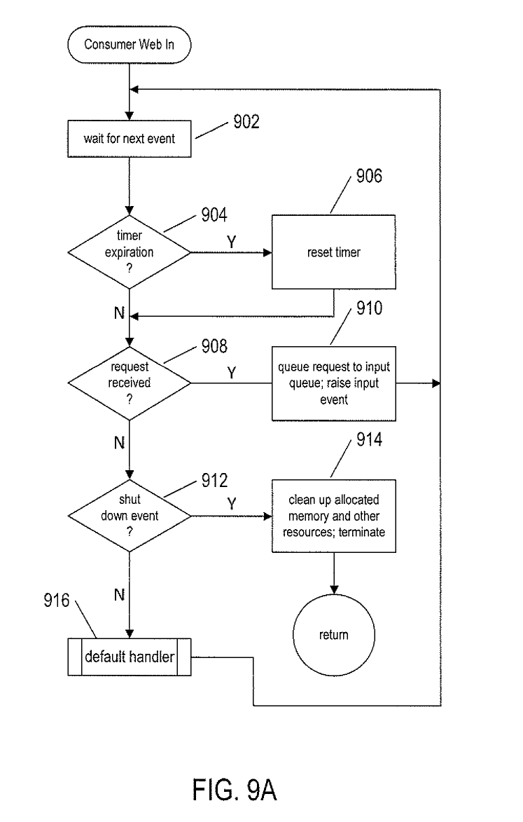

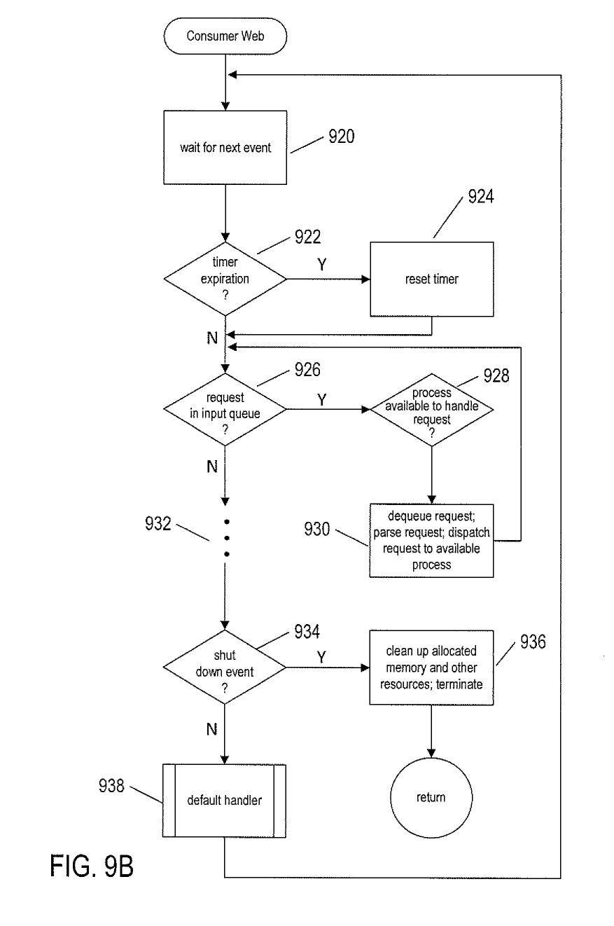

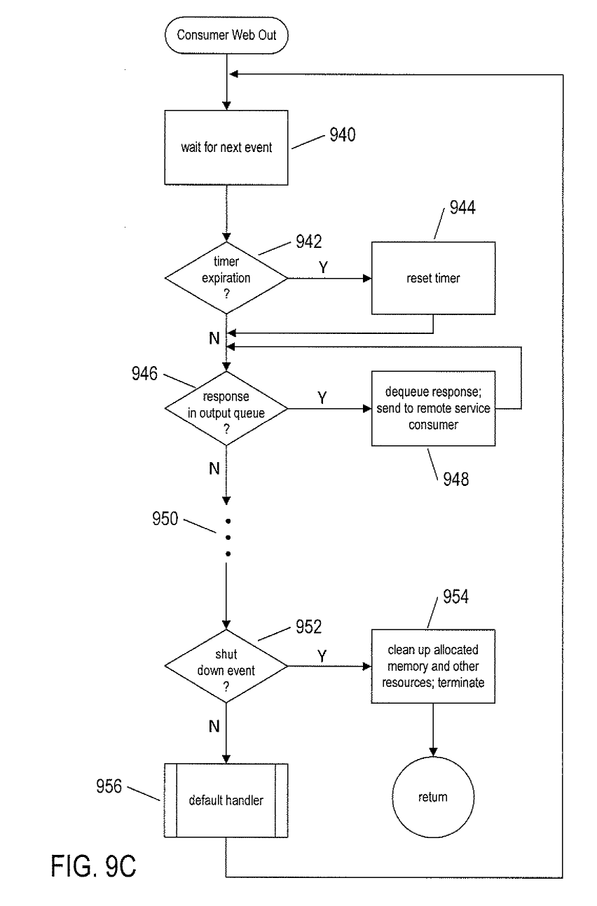

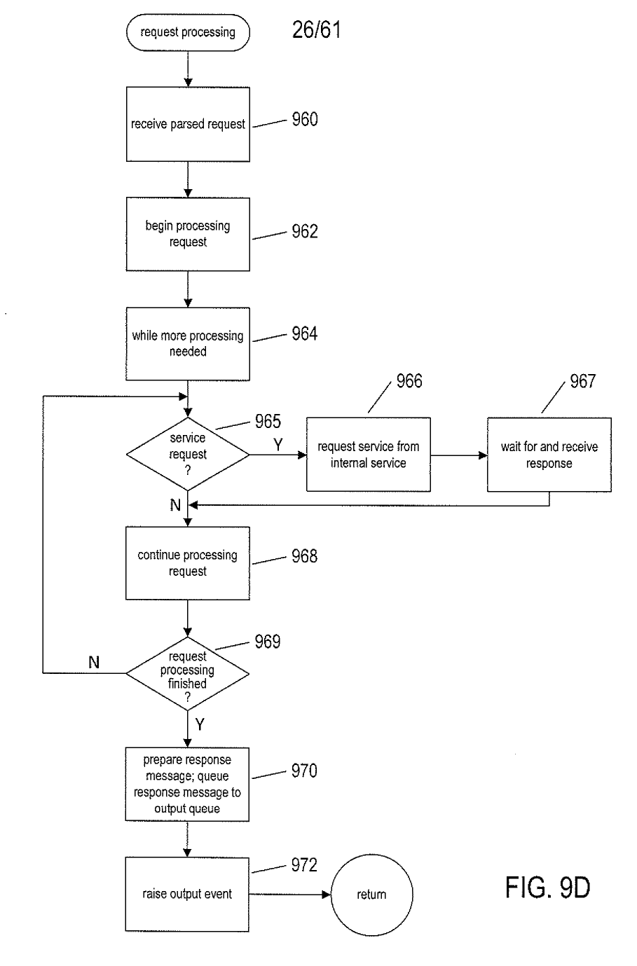

FIGS. 9A-D include control-flow diagrams that illustrate operation of the consumer-web-application servers (706 in FIG. 7). FIG. 9A shows a control-flow diagram for a routine “Consumer Web In.” This routine represents an asynchronous server process that listens to operating-system-provided communications ports for incoming messages. This asynchronous process operates as a continuous loop. The process waits, in step 902, for a next event. When a next event occurs, the process undertakes various event-determination steps to determine what type of event has occurred. In step 904, the process determines whether or not the recently occurring event is a timer expiration. If so, then, in step 906, the process resets the timer. A timer is used to periodically awaken the process to make sure that incoming messages are handled in a timely fashion, despite any failures in the incoming-message wakeup and/or interrupt mechanisms. When a new request has been received by the server, as determined in step 908, the process queues the request to an input queue and raises an input event, in step 910. Otherwise, when a shut-down event has occurred, as, for example, when the consumer-web application is terminated or the virtual server virtually or physically powered down, as determined in step 912, the process cleans up any allocated memory and other allocated resources and terminates, in step 914. Other types of events are handled by a default handler 916.

FIG. 9B provides a control-flow diagram for the main loop of the consumer-web application run by the consumer-web-application servers. In step 920, this main loop waits for the occurrence of a next event. As with the process described with reference to FIG. 9A, when the next-occurring event is a timer expiration, as determined in step 922, then the timer is reset in step 924. The timer is used to periodically awaken the main loop in case the occurrence of input events fail to awaken the process. When there is a new request queued to the input queue, as determined in step 926, and when there is an available process to handle the request represented by the queued request, as determined in step 928, then, in step 930, the consumer-web process dequeues the request from the input queue, parses the request, and dispatches the request to a suitable available process. Ellipsis 932 indicates that other types of events may be handled by the consumer-web-application main loop. When a shutdown event has occurred, as determined in step 934, the consumer-web-application process cleans up any allocated memory into other allocated resources and then terminates, in step 936. A default handler 938 handles other types of events.

FIG. 9C provides a control-flow diagram for a routine “Consumer Web Out” that represents an asynchronous process within the consumer-web-application server for returning responses to remote service consumers. As with the main-loop process described with reference to FIG. 9B and the incoming-request-handling process discussed with reference to FIG. 9A, above, the response-transmitting process operates as an endless loop. In step 940, the response-transmitting process waits for the occurrence of a next event. When the next-occurring event is a timer expiration, as determined in step 942, then the timer is reset in step 944. When there is a response in the output queue, as determined in step 946, the process dequeues the response and transmits the response, through an operating-system interface to a communications subsystem, to a remote service consumer, in step 948. Ellipsis 950 indicates that other types of events may be handled by the response-transmitting process. In the case that the next-occurring event is a shut-down event, as determined in step 952, the process cleans up any allocated memory and other resources and terminates, in step 954. Other types of events may be handled by a default handler 956.

FIG. 9D provides a control-flow diagram for a request-processing process to which requests are dispatched by the consumer-web-application server main loop, discussed above with reference to FIG. 9B. In step 960, the request-processing process receives a parsed request. In step 962, the request-processing process begins processing the request. In the while-loop of steps 964-969, entered when request processing needs to make a call to one of the many service providers, as detected in step 965, the request-processing process requests a service from an internal service-providing server, in step 966, and waits to receive a response to the request in step 967. Once a response has been received, the request-processing process continues processing the received request in step 968. When request processing has finished, as determined in step 969, then the request-processing process prepares a response message and queues the response message to the output queue in step 970. Otherwise, when as additional service call is needed, the while-loop iterates again. Finally, in step 972, the request-processing process raises an output event.

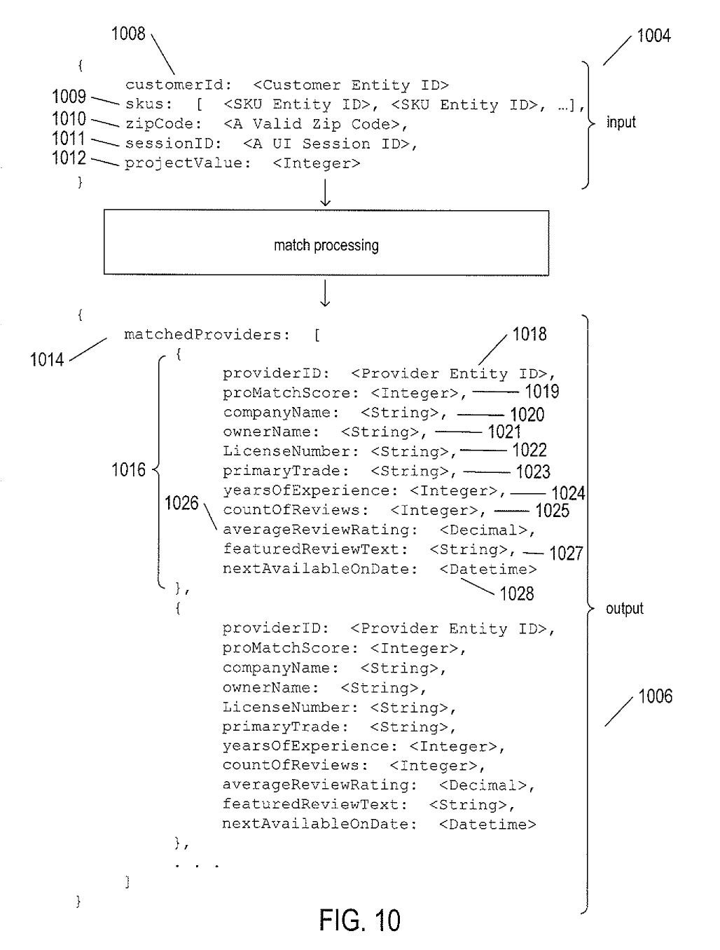

Next, the specific request processing that is carried out when, as discussed above with reference to FIG. 1F, a service consumer inputs a mouse click to the “find a pro” button 142, is discussed with reference to pseudocode and flow diagrams. The main activity in request processing for the information-exchange transaction initiated by service-consumer input to the “find a pro” feature 142 is a match-processing process in which information, collected and temporarily stored on behalf of the service consumer during previous transactions described above with reference to FIGS. 1A-E, is used to identify an ordered set of candidate service providers who can undertake and complete the projects in the service-consumer's project list. FIG. 10 illustrates a match-processing routine that represents the service-provider matching process carried out by the automated system. The match-processing process is represented by the rectangular block 1002. Input to the match-processing process is shown in pseudocode block 1004. Output from the match-processing process is shown in pseudocode block 1006. The input to the match-processing process, in one implementation, includes a customer identifier 1008, a list of SKUs corresponding to projects in the service consumer's project list 1009, a zip code for the location in which the service or services are to be performed 1010, a session ID 1011 that identifies the current session context, each session corresponding to a series of information-exchange transaction carried out between the service consumer and automated system, and an estimated project cost, or project value 1012. The match-processing process 1002 uses the input information to identify a set of appropriate candidate service providers. In FIG. 10, the set of candidate providers is shown, in pseudocode, as the list “matchedProviders” 1014, each provider in the list represented by a block of values, such as the block of values 1016 that represent a first candidate provider. The list is sorted in descending order based on a match score computed for each candidate provider by the automated system. Computation of the match score is discussed in great detail, below. Each candidate service provider is described by a provider identifier 1018, the match score 1019, a company name 1020, an owner name 1021, a license number 1022, an indication of the provider's primary trade 1023, a number of years of experience 1024, the number of reviews submitted by service consumers for the provider 1025, an average review rating 1026, a text block containing portions of one of the service-consumer's reviews 1027, an indication of the provider's next available appointment time 1028 and provider responsiveness.

Of course, the input information and output information may vary from implementation to implementation, depending on the types of data stored within the automated system to describe service-consumer requests and service providers, the particular web-page interface accessed by service consumers, the types of services being requested by a service consumer, the category of service consumers to which the service consumer belongs, geographical location, state and country in which the service is being contracted and in which the service is to be performed, business and legal conditions and considerations, and on many other factors and parameters. FIG. 10 illustrates one particular implementation of a routine that encodes functionality of the match-processing process.

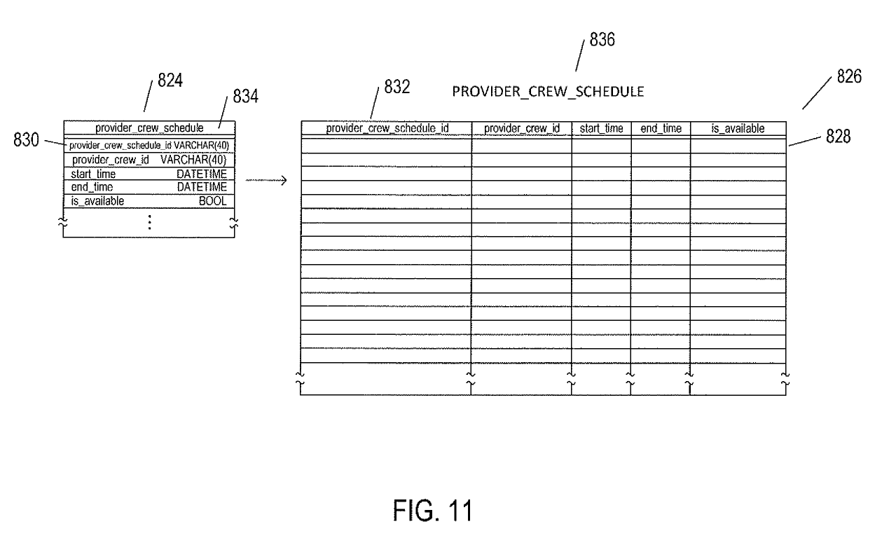

In the following discussion, a relational database is assumed to be used by the automated system to store the many data objects of the data-object types illustrated in FIGS. 8A-C. FIG. 11 illustrates the relational-database perspective on data storage. In FIG. 11, the provider-crew-schedule data-object type 824, initially shown in, and described with reference to, FIG. 8B is illustrated as being transformed into a relational-database table 826. Each row in the relational database table, such as row 828, represents an instance of a data object of the data-object type represented by the provider-crew-schedule data-object type 824. Each column in the relational-database table 826 represents a field or entry of the provider-crew-schedule database-object type. For example, the provider-crew-schedule-id field 830 is represented by the first column 832 in the relational database table. The columns are associated with the data types corresponding to the fields in the provider-crew-schedule database-object type. For example, the provider-crew-schedule-id column 832 includes entries of type “VARCHAR(40).” Lower-case data-object names, such as “provider_crew_schedule” 834 are transformed to uppercase relational-database names 836. The column names of the relational-database table 826 are identical to the field names and the database-object type. A relational-database is assumed in order to use the structured query language (“SQL”) and embedded SQL to illustrate various data-related operations.

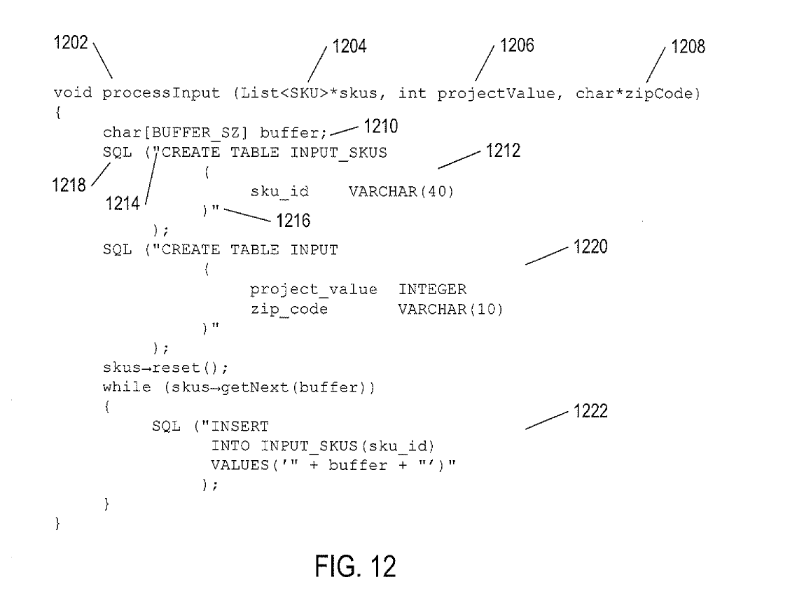

FIG. 12 shows a pseudocode implementation of a routine “processInput” that processes certain of the input data (1004 in FIG. 10) that is input to the match-processing process (1002 in FIG. 10). In particular, the routine “processInput” processes the list of SKUs 1204, the project value 1206, and the zip code 1208 supplied as input items 1009, 1012, and 1010 in FIG. 10. A local variable “buffer” 1210 is used to store SKU identifiers extracted from the list of SKUs 1204. The routine “processInput” 1202 uses embedded SQL to carry out relational-database operations. SQL statements, such as the CREATE TABLE statement 1212, are included as character strings within quotes, such as quotes 1214 and 1216, and supplied as arguments to the SQL-execution procedure “SQL” 1218. This routine is assumed to return the first of any data items produced by execution of the SQL statement. In many cases, the returned values are ignored. The first embedded SQL statement creates a temporary relational-database table “INPUT_SKUS.” A second embedded SQL statement 1220 creates a temporary relational-database table “INPUT.” The temporary relational-database table “INPUT_SKUS” includes a single column sku_id that contains SKU identifiers extracted from the list of SKUs 1204. The temporary relational-database table “INPUT” includes two columns, and a single row, to store the input project value 1206 and the input zip code 1208. Finally, in a while-loop 1222, each SKU identifier extracted from the input list of SKUs 1204 is inserted into the temporary relational-database table “INPUT_SKUS.” The temporary tables “INPUT_SKUS” and “INPUT” provide a means for introducing input values into relational-database tables that can be subsequently manipulated by embedded SQL statements in the matching routine.

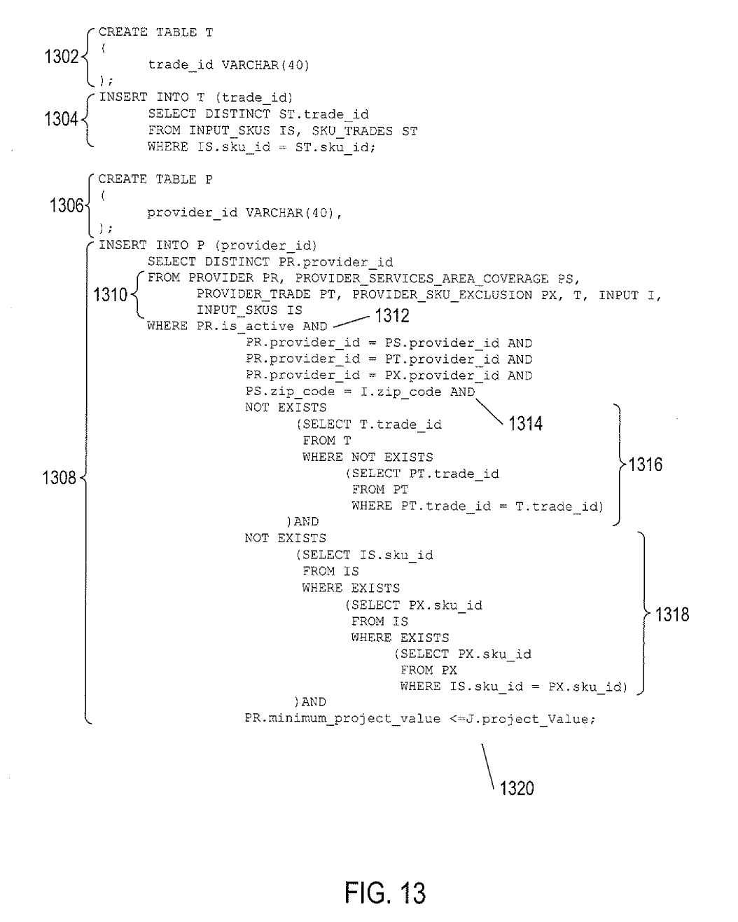

FIG. 13 shows four SQL commands that carry out initial selection of providers from the relational database that contains the relational-database tables discussed above with reference to FIGS. 8A-C and FIG. 11. A first SQL command 1302 creates a temporary table “T” to store trade identifiers. A second SQL command 1304 inserts trade identifiers into the temporary table “T.” The trade identifiers are those trade identifiers that are associated, by entries in the relational-database table SKU_TRADES, to the input SKUs stored in the temporary relational-database table “INPUT_SKUS” and with entries in the SKU_TRADES relational database table. The trade identifiers inserted into temporary table “T” are therefore the trade identifiers corresponding to the items in a service consumer's project list. A third SQL command 1306 creates an additional relational-database temporary table “P” for storing provider identifiers for candidate providers.

A fourth SQL command 1308 selects identifiers corresponding to providers as identifiers for candidate providers and inserts them into the temporary relational-database table “P.” Selection of the candidate providers is carried out by a multi-way join 1310 of the tables PROVIDER, PROVIDER_SERVICES_AREA_COVERAGE, PROVIDER_TRADE, PROVIDER_{—} SKU_EXCLUSION, T, INPUT, and INPUT_SKUS. The initial candidate providers are providers who are currently active 1312, who provide services in areas with the same zip code as the zip code associated with the service request made by the service consumer 1314, who have listed, as trades that they are qualified to work in, all of the trades associated with the input SKUs 1316, who have not listed, as SKU exclusions, any of the SKUs in the input SKU list 1318, and who have a minimum project value or minimum charge less than or equal to the estimated project value for the requested service 1320. The final SQL command 1308 identifies all of the service providers for which data is stored in the automated system that meet these criteria and place their provider identifiers into the temporary relational-database table “P.”

The SQL commands shown in FIG. 13 may be executed as embedded SQL commands from a procedural-language program, as are the SQL commands included in the routine “processInput” discussed above with reference to FIG. 12. Again, there are many different ways to store data in computer systems and many different procedural and non-procedural methods for extracting desired data. The SQL commands shown in FIG. 13 are one example of a portion of an implementation of an automated method for collecting provider identifiers for an initial set of candidate providers.

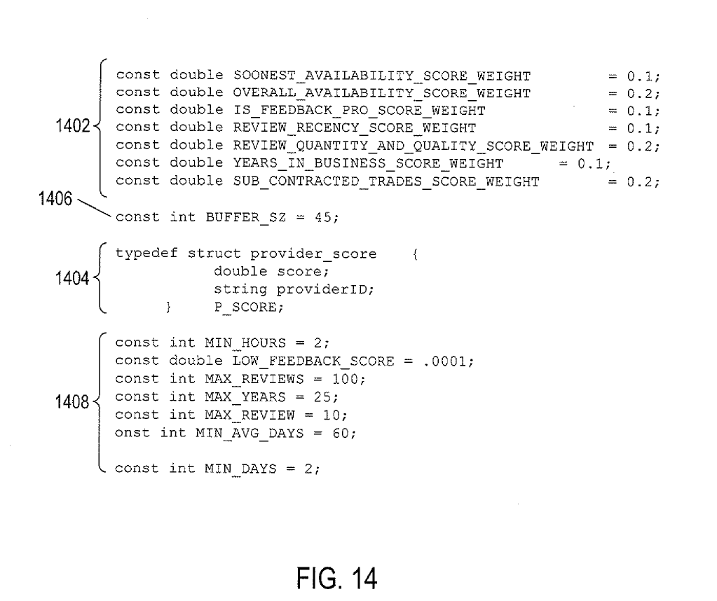

FIG. 14 shows a number of pseudocode constant declarations and a type declaration used in subsequent pseudocode descriptions of the remaining portion of the provider-matching process. A first set of constants 1402 represent weights that are used to multiply component scores in order to produce a final match score for each candidate provider. These weights are associated with particular considerations and characteristics of providers that are evaluated to produce the matching score. These considerations include the provider's next appointment slot, the overall availability of the provider to provide services, whether or not the provider uses the service consumer feedback facilities provided by the automated system, how recently the most recent review was provided by a service consumer for the provider, the quantity and quality of reviews provided by service consumers for the provider, the number of years that the provider has been in business, and the portion of trades associated with project SKUs that the provider subcontracts out to other service providers. A type declaration 1404 for a structure “provider_score” is used to associate matching scores with provider identifiers for local in-memory storage of scored candidate providers. Additional constants define a buffer size 1406 and various minimum and maximum values used for computing component scores 1408.

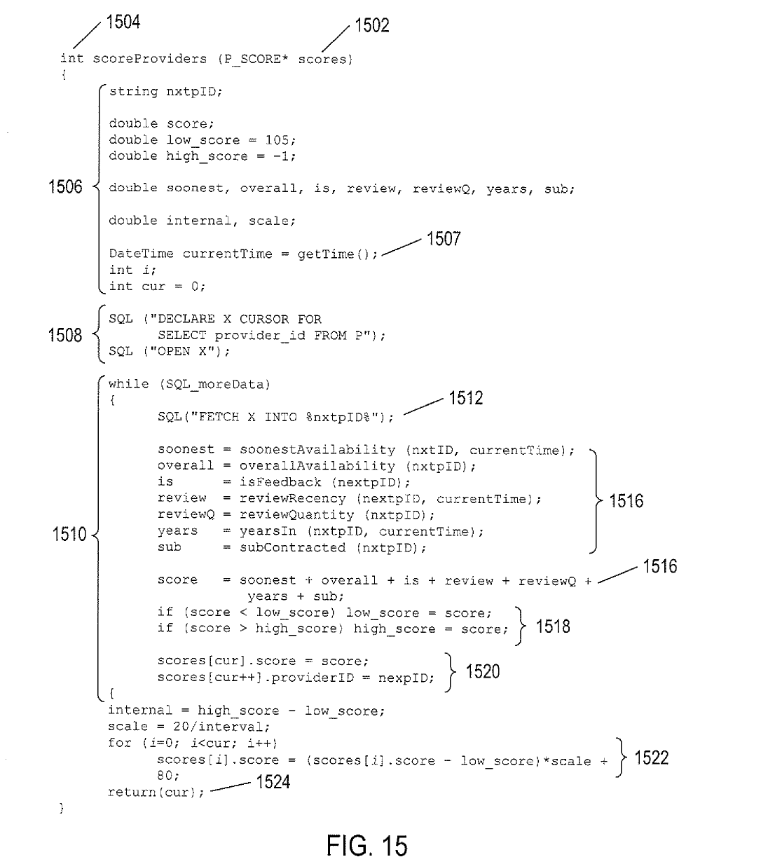

FIG. 15 provides pseudocode for a routine “scoreProviders” that computes scores for the initial set of candidate providers. The routine “scoreProviders” receives a pointer to a buffer for storing provider_score structures for each of the candidate providers 1502 and returns an integer value 1504 indicating the number of candidate providers for which scores have been placed into the buffer “scores” 1502. The routine “scoreProviders” initially includes a number of local-variable declarations 1506. Two embedded SQL statements 1508 are executed to select the provider identifiers from the temporary relational-database table “P” and to open a cursor used to retrieve one provider identifier at a time in a subsequent while-loop 1510. The while-loop 1510 processes each provider identifier extracted from the temporary relational-database table “P.” One of the local variables, “currentTime,” is set to the current time by a call to an operating system current-time function 1507. The embedded SQL command 1512 is used to place a next provider identifier into the local variable “nxtpID.” Then, in the block of pseudocode 1514, seven component scores are computed by calls to component-score-computing routines and placed in the local variables “soonest,” “overall,” “is,” “review,” “review queue,” “years,” and “sub.” The component scores are related to the soonest available appointment, the overall availability of the service provider, whether or not the service provider uses the feedback facilities within the automated system, how recently the most recent review was received for the provider, the overall quality and quantity of reviews provided by service consumers for the provider, the years that the provider has been in business, and the portion of trades associated with the service consumer's project list that are subcontract by the provider. Next, an overall score is computed 1516 for the service provider by adding the component scores computed in the pseudocode block 1516. The local variables “low_score” and “high_score” are used to identify the lowest and highest score produced for any of the candidate service providers 1518. In the last two lines of the while-loop 1520, the computed score and provider identifier for the currently considered provider are entered into a provider-score structure within the input buffer “scores.” When scores have been computed and stored for all of the providers in the while-loop 1510, a final for-loop 1522 is executed to scale all the scores to a range of 80 to 100. The number of provider_score structures stored in the input buffer is returned on line 1524.

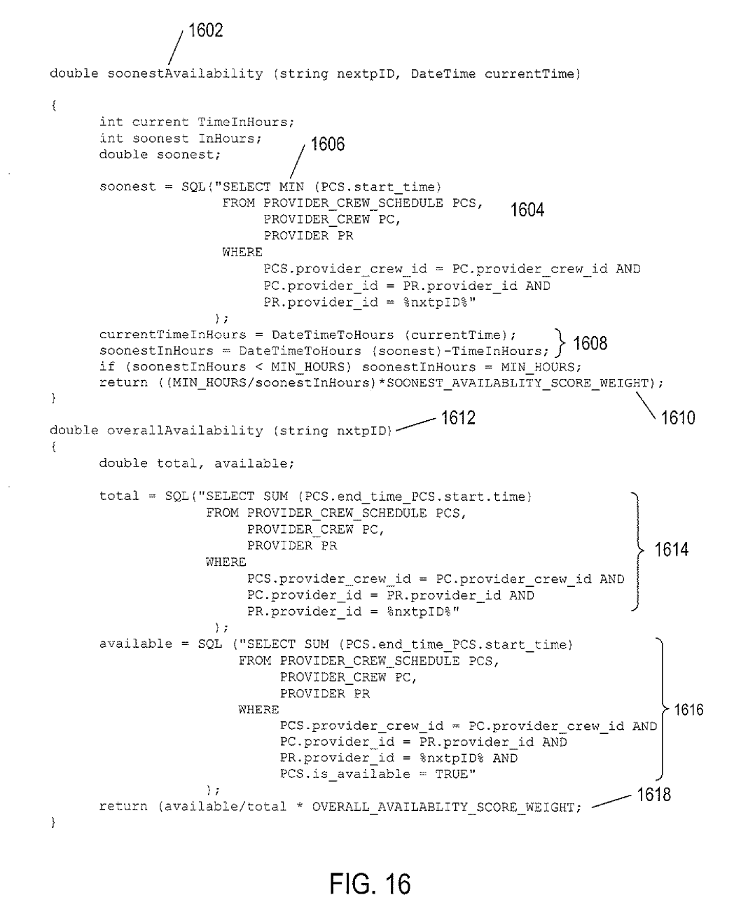

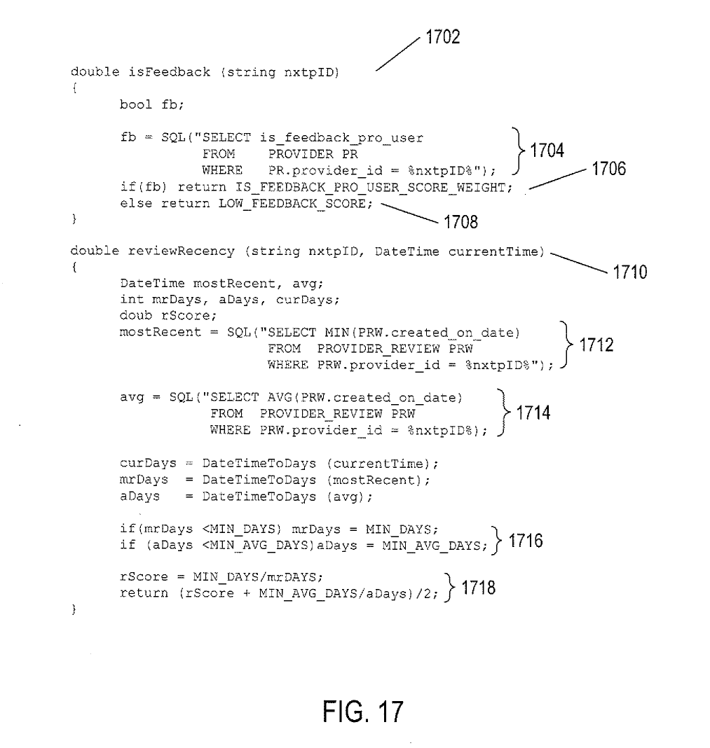

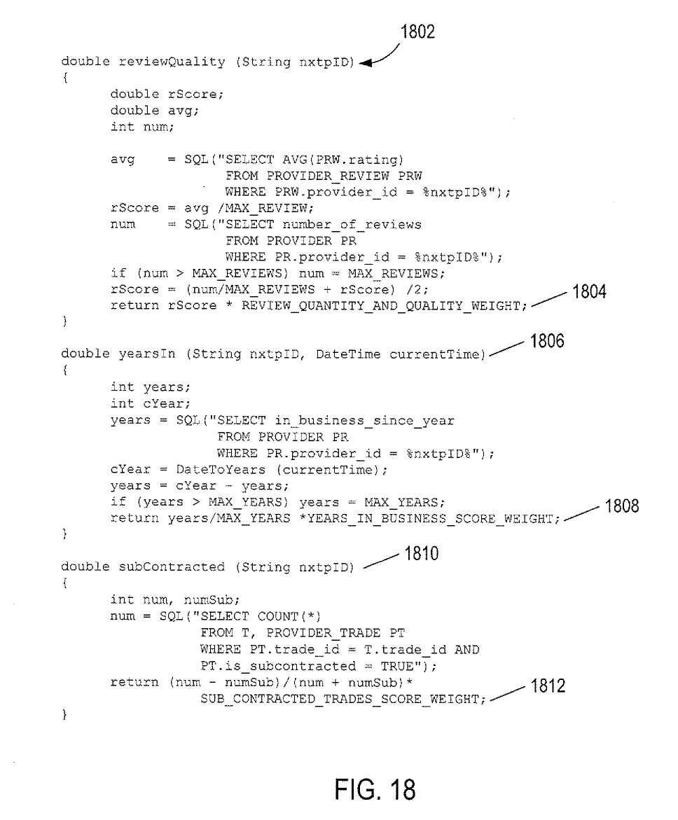

FIGS. 16-18 provide pseudocode implementations of the seven routines, called in the pseudocode block 1516 shown in FIG. 15 of the routine “scoreProviders,” that compute component scores subsequently added together to form the match score for a service provider. Each of these routines uses embedded SQL commands to obtain the information from the relational database needed to compute the component score. The routine “soonestAvailability” 1602 computes a first appointment time for a member of the provider's crew using a join over the relational-database tables PROVIDER_CREW_SCHEDULE, PROVIDER_CREW, and PROVIDER 1604. The pseudo implementation uses an SQL function “MIN” sufficiently intelligent to determine the minimum start time from entries with data type “DateTime” 1606. The soonest appointment time and current time are converted into hours and the current time is subtracted from the soonest appointment time to produce the number of hours until the soonest appointment time, stored in the variable “soonestInHours” in lines 1608. When the number of hours to the soonest appointment time is less than the constant MIN_HOURS, then the variable “soonestInHours” is set to MIN_HOURS. In the final line 1610, a component score is computed as MIN_HOURS divided by “soonestInHours” and then multiplied by the weight factor SOONEST_AVAILABLITY_SCORE_WEIGHT.

The routine “overallAvailability” 1612 computes a component score for the overall availability of the provider based on the schedule of appointment times for the provider. A first embedded SQL command is used to compute the total schedule time for the provider 1614, which is placed in the local variable “total.” A second embedded SQL command 1616 is employed to compute the total amount of appointment time that is currently available for scheduling, with the available appointment time placed into the local variable “available.” The component score is then computed, on line 1618, by dividing the value in the local variable “available” by the value in local variable “total” and then multiplying by the weighting factor OVERALL_AVAILABILITY_SCORE_WEIGHT. Note that it is assumed that the value stored in local variable “total” is non-zero.

The routine “isFeedback” 1702 determines, using the embedded SQL statement 1704, whether a provider uses feedback facilities of the automated system. If so, then the component score returned by the routine “isFeedback” is the weighting factor IS_FEEDBACK_PRO_USER_WEIGHT, on line 1706. Otherwise, a very small value represented by the constant LOW_FEEDBACK_SCORE is returned on line 1708.

The routine “reviewRecency” 1710 computes a component score related to how recently a review was provided for the service provider by a service consumer to the automated system. A first embedded SQL command 1712 determines the date of the most recent review and a second SQL command 1714 determines the average creation date for reviews submitted for the service provider. These values are converted to days and adjusted to have minimum values MIN_DAYS and MIN_AVG_DAYS, respectively, on lines 1716. A component score is computed as the average of the ratios of the constant MIN_DAYS to the computed number of DAYS from the most recently created review and the ratio of MIN_AVG_DAYS to the average number of days since reviews provided for the service provider were provided by service consumers on lines 1718. In alternative implementations, the routine “reviewRecency” may compute the component score directly from, or partly from, values of fields in the provider data object that describes a service provider, such as the field most_recent_review_data in a data object of the provider data object type 820 in FIG. 8B.

The routine “reviewQuality” 1802 computes a component score, on line 1804, that represents a weighted average of the average review score to a maximum possible review score, represented by the constant MAX_REVIEW, and the ratio of the number of reviews submitted to the automated system for the service provider to a constant value MAX_REVIEWS. The score is weighted by the weighting factor REVIEW_QUANTITY_AND_QUALITY_WEIGHT. The routine “yearsIn” 1806 returns a computed component score, on line 1808, equal to the ratio of the years that the service provider has been in business to a maximum number of considered years, MAX_YEARS, multiplied by the weighting factor YEARSIN_BUSINESS_SCORE_WEIGHT. Finally, the routine “subContractor” 1810 returns a component score computed as the number of trades not subcontracted minus the number of trades that are subcontracted divided by the number of trades that are not subcontracted plus the number of trades that are subcontracted, this ratio then multiplied by the weighting factor SUB_CONTRACTOR_TRADES_SCORE_WEIGHT, on line 1812. In alternative implementations, the routine “reviewQuality” may compute the component score directly from, or partly from, values of fields in the provider data object that describes a service provider, such as the fields average_review_rating and number_of_reviews in a data object of the provider data object type 820 in FIG. 8B.

Any of many different alternative methods can be used to compute the component scores computed by the seven routines shown in FIGS. 16-18. The different, alternative methods may use any of various linear and nonlinear computations to produce scores within a possible score range reflective of the above-discussed considerations and characteristics related to service providers.

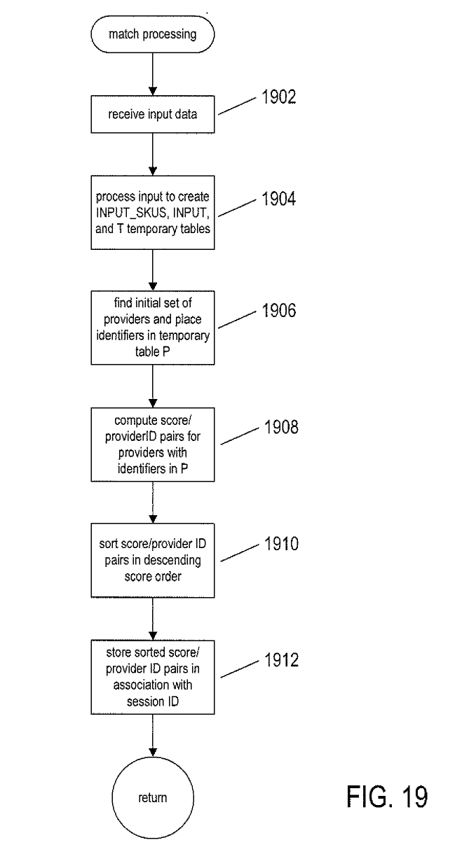

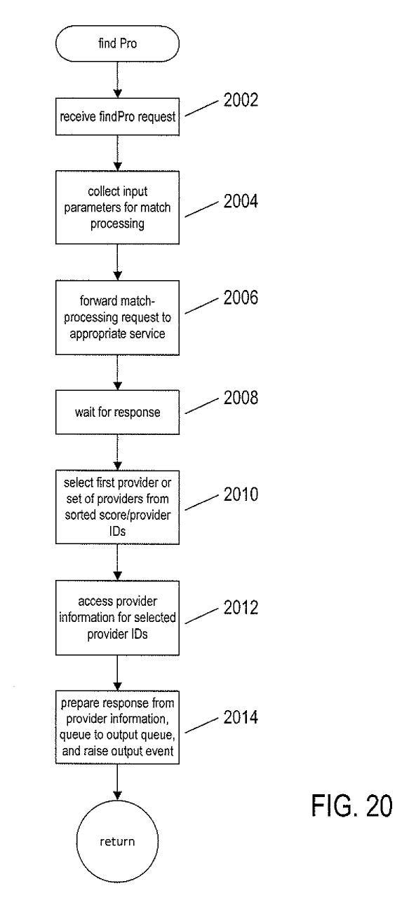

FIGS. 19 and 20 provide control-flow diagrams that illustrate implementation of the processing routine that carries out the service-provider matching process discussed above with reference to FIGS. 11-18. FIG. 19 includes a control-flow diagram for the match-processing routine already described with reference to FIGS. 10-18. In a first step 1902, the match-processing routine receives input data (pseudocode block 1004 in FIG. 10). In step 1904, the match-processing routine processes the input data to create the temporary relational database tables INPUT_SKUS, INPUT, and T, as described above with reference to FIG. 12. In step 1904, the match-processing routine identifies an initial set of candidate providers and places provider identifiers for these candidate providers in the temporary relational-database table P, as discussed above with reference to FIG. 13. As discussed above, the initial candidate service providers are those providers who are currently actively providing services, whose minimum project value is lower or equal to the initial estimate for the service consumer's projects, who provide services in the zip code associated with the location in which service provision is desired by the service consumer, who practice the trades corresponding to the service consumer's project, and who do not have any SKU exclusions for SKUs corresponding to the service consumer's projects. In step 1908, the match-processing routine produces score/provider-identifier pairs for each of the candidate providers identified by identifiers stored in the temporary relational-database table P, as discussed above with reference to FIG. 15. In step 1910, the match-processing routine sorts the score/provider-identifier pairs in descending score order, so that the service providers associated with the highest scores appear first in the list or set of candidate providers. Finally, in step 1912, the sorted score/provider-identifier pairs are stored within the automated system in association with the session identifier for the current session or set of transactions for which the set of sorted candidate providers has been determined by the match-processing routine.

FIG. 20 provides a control-flow diagram for a routine “find Pro” that represents the request handling routine for a request initiated by input of a mouse click to the “find a pro” input feature 142 discussed above with reference to FIG. 1F. In step 2002, the routine receives the “find Pro” request from the main consumer-web loop discussed above with reference to FIG. 9B. In step 2004, the routine collects the input parameters needed for match-processing (1004 in FIG. 4). These input parameters include the session identifier for the current set of transactions between the automated system and the service consumer, the SKUs associated with the items in the service consumer's project list, obtained during previous web-page-based interactions and stored in the automated system in association with the session ID, the customer identifier for the user, and the zip code and project value obtained during previous web-page-based interactions, as discussed above with reference to FIGS. 1A-E. In step 2006, the routine forwards a match-processing request to an appropriate service. In the described implementation, the match-processing request is carried out by the provider-service-application servers (716 in FIG. 7). In step 2008, the routine waits for a response from the service. In step 2010, the routine selects a first candidate provider or a first set of candidate providers from the sorted score/provider-identifier pairs returned by the match-processing service. In step 2012, the routine accesses the service-provider information for the selected service providers from the database using the provider identifiers selected in step 2010. The information for each of the set of highest-scored service providers may be incorporated into a list, such as the list “matchedProviders” 1006 discussed above with reference to FIG. 10. Finally, in step 2014, the routine prepares a response message that includes information for display in the web page discussed above with reference to FIG. 1G, queues the response message to the output queue, and raises an output event.

### SMS/MMS Communications with Consumers and Providers

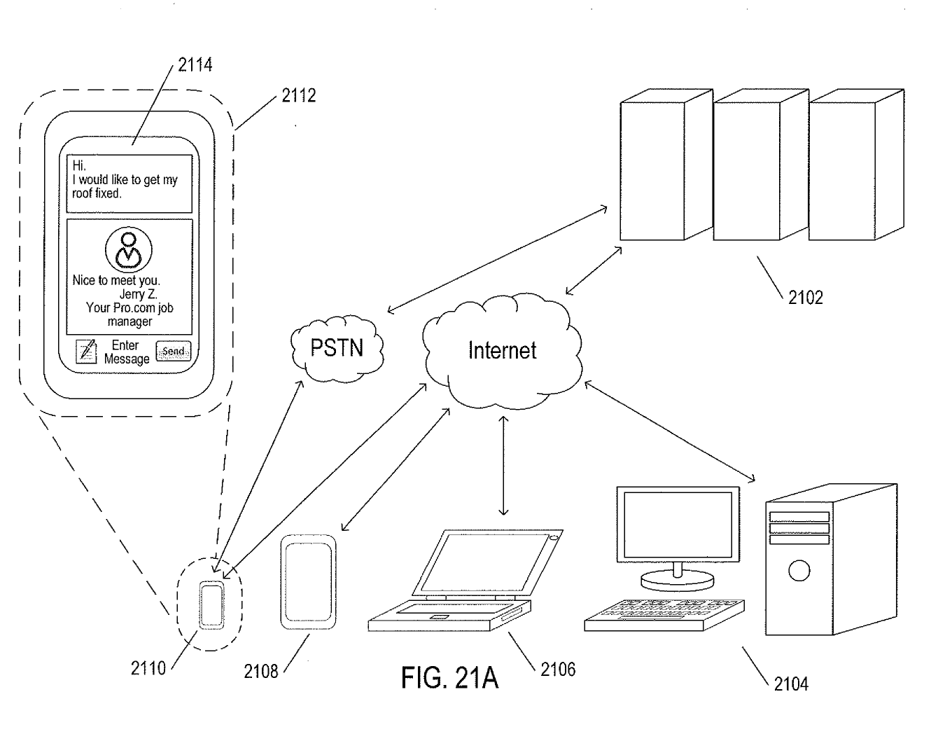

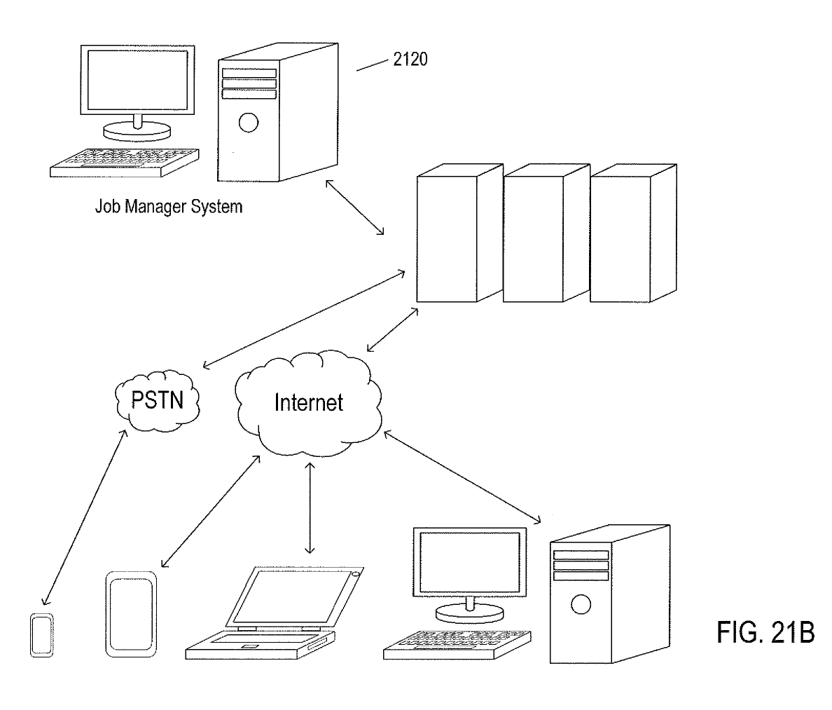

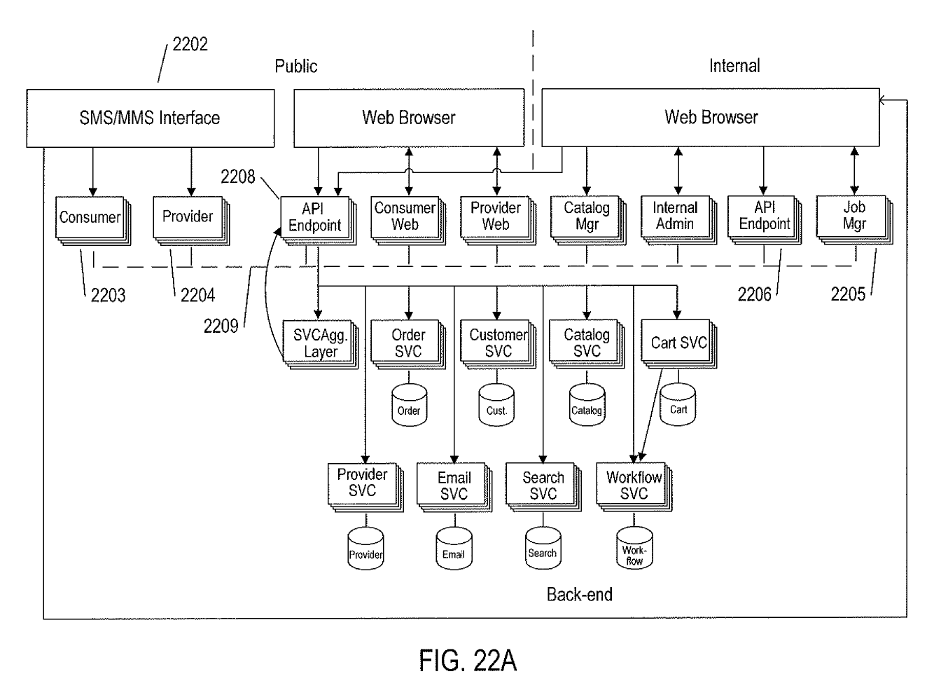

FIGS. 21A-B illustrate short-message-service (“SMS”) and multimedia-messaging-service (“MMS”) communications between smart-phone-using consumers and providers and the automated system that matches service providers with service consumers discussed above with reference to FIGS. 1-20. In the following discussion, the automated system that matches service providers with service consumers and facilitates service provision to service consumers is referred to as the automated service-provision brokerage (“ASB”). As shown in FIG. 21A, the ASB 2102 communicates with a variety of different types of consumer and provider devices, including personal computers 2104, laptops 2106, tablets 2108, and cell phones 2110, including smart phones. In general, as discussed above, communications between consumers and providers and the ASB, when the consumers and providers use PCs, laptops, and tablets, is generally based on web pages provided by an ASB website and displayed to consumers and providers on the consumer and provider devices by a web browser. In the case of smart phones 2110, a mobile-device-configured website can provide a similar interface to consumers and providers. However, as shown in FIG. 21A, smart phones not only provide voice communications and for display of web pages via a mobile web browser, but also provide for communications with remote individuals and systems via SMS and MMS messaging. While SMS and MMS may be available to users of PCs, tablets, and other such devices, the vast majority of SMS and MMS message exchanges are carried out using smart phones. SMS messaging is implemented by SMS centers in combination with mobile-communications carriers and infrastructure as well as the public switched telephone network (“PSTN”) and provides store-and-forward transmission of SMS messages among smart phones. Although originally limited to relatively short text messages of 160 or less characters, SMS has been extended to provide transmission of multi-part or segmented messages each comprising up to 255 short text messages. MMS messaging allows for transmission of photographs, graphics, and other multi-media content, including short videos, among smart phones. MMS messages are transmitted differently than SMS messages, with MMS centers facilitating the transmission. While relatively slowly adopted, following initial deployment in 2008, many hundreds of billions of MMS messages are now transmitted between smart-phone users each year around the world.

As shown in FIG. 21A, in inset 2112, the SMS interface provided on most cell phones and the SMS-and-MMS interface provided on many smarts phone is generally quite different than the interface provided by a web browser. In many smart phones, including Android devices, SMS and MMS messages are organized into threads, or conversations, and graphically displayed 2114 on the smart-phone screen as a scrollable, ordered sequence of messages within a thread or conversation. Many smart phone users prefer SMS and MMS messaging to email and other types of text-based and graphics-based communications, and even to voice communications. Many younger smart-phone users almost exclusively communicate by SMS and MMS messaging. As a result, it is desirable that the ASB supports SMS-and-MMS-based communications with consumers and service providers. However, SMS and MMS communications differ significantly from communications based on web sites and web pages. In general, a browser may display large amounts of graphical content on web pages that can be easily scanned and manipulated by users using input and navigational facilities, including keys, mice, touchpads, and touch-sensitive display screens, provided by PCs, laptops, and tablets. Web pages are often interactive, providing a variety of different input and display features. By contrast, the screen area provided by smart phones for viewing SMS and MMS messages is relatively constrained in size and lacking in the many interactive features provided by web pages. SMS and MMS messaging therefore generally follows a conversation model in which communicating parties exchange relatively short messages with one another. As a result, SMS-and-MMS-based communications between service consumers, service providers, and the ASB generally follows a fundamentally different model than website, web page, and browser-based communications, discussed above. It should be noted that, as discussed below, the ABS can exchange messages and information by SMS-messaging only, MMS-messaging only, or a combination of SMS-and-MMS messaging.

Not only are the SMS and MMS message displays relatively static, non-interactive, and size-constrained, they are also relatively format-free and far more open-ended with regard to content and style. Because web pages display a rich and diverse set of input features and information-display features, including pull-down option lists, option-selection buttons, and other such features, exchange of information via web pages and browsers can be advantageously constrained in order to ensure that requests and responses are relatively well posed, which, in turn, facilitates full automation of web sites. By contrast, SMS and MMS information exchange is generally so open-ended that, even using natural language processing (“NLP”) and other automation technologies, it is currently infeasible to provide fully automated information exchanges by the ASB via SMS and MMS communications. As a result, supporting SMS-and-MMS-based communications by an ASB involves not only providing the technological platforms and connections to provide for exchange of SMS and MMS messages between the ASB and service consumers and service providers, but also providing for human intervention and supervision, on the ASB side of the information exchanges, so that the SMS and MMS messages returned by the ASB in response to received SMS and MMS messages from service consumers and service providers makes sense and advance information transactions efficiently. Thus, as shown in FIG. 21B, a significant component of the ASB for facilitating SMS-and-MMS-based communications with service consumers and service providers is a job-manager communications console 2120 provided to each of multiple human job managers to allow the job managers to directly or indirectly interact, through a web-page-based communications console, with service consumers and service providers communicating with the ASB via SMS and MMS messaging. As a result, SMS-and-MMS-based communications between service consumers, service providers, and the ASB often involve three or more entities, including the service consumer or service provider, an automated service-consumer or service-provider application running within the ASB, and a job manager communicating via a communications console 2120 provided by a job-manager application within the ASB.

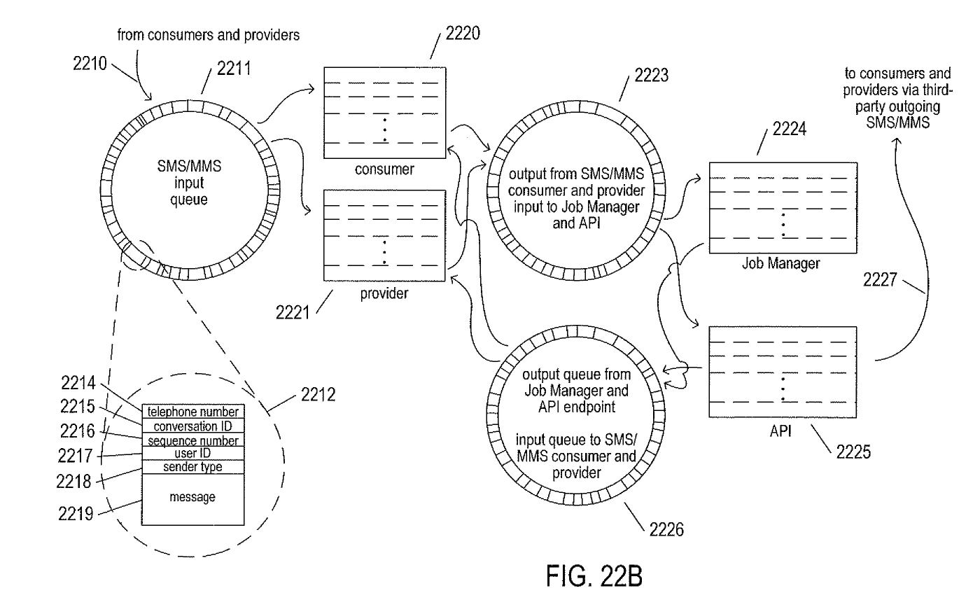

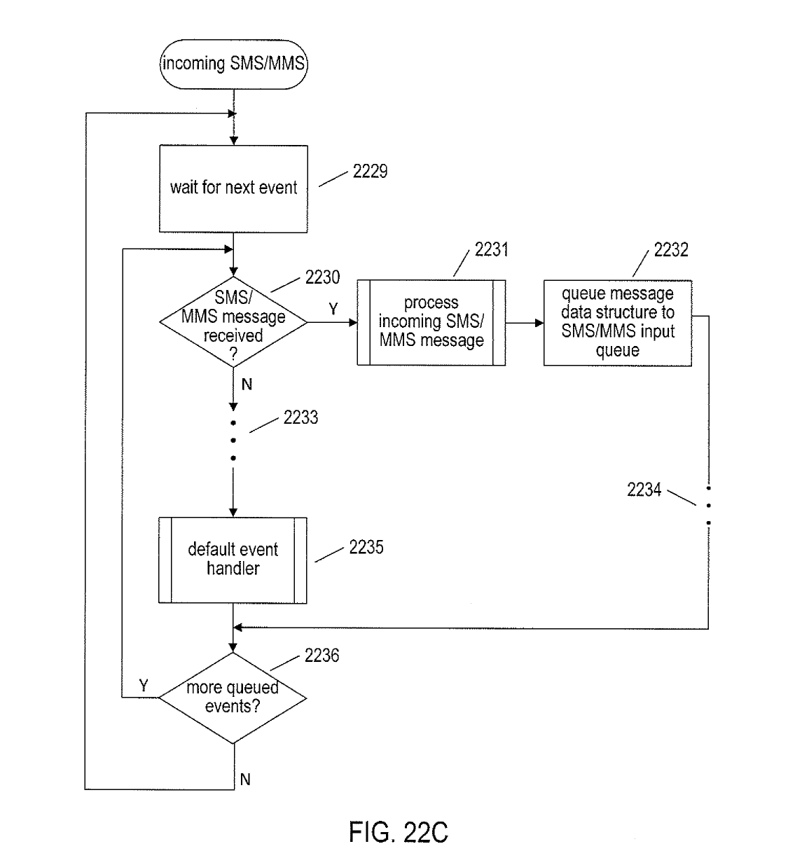

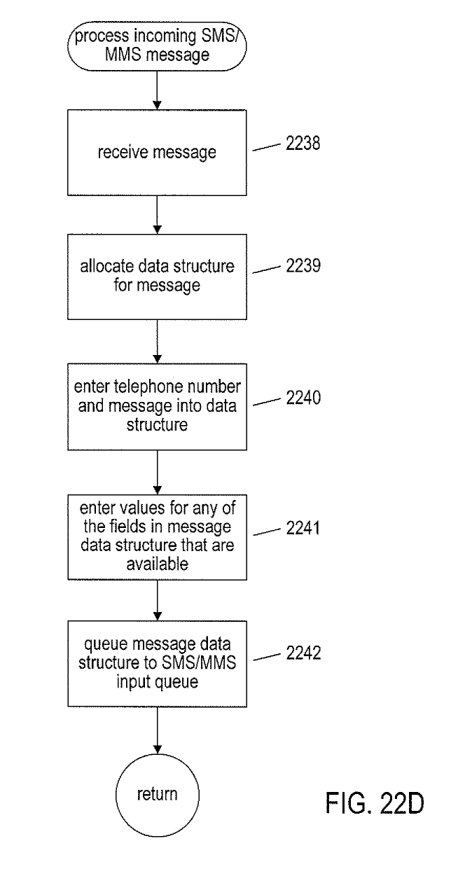

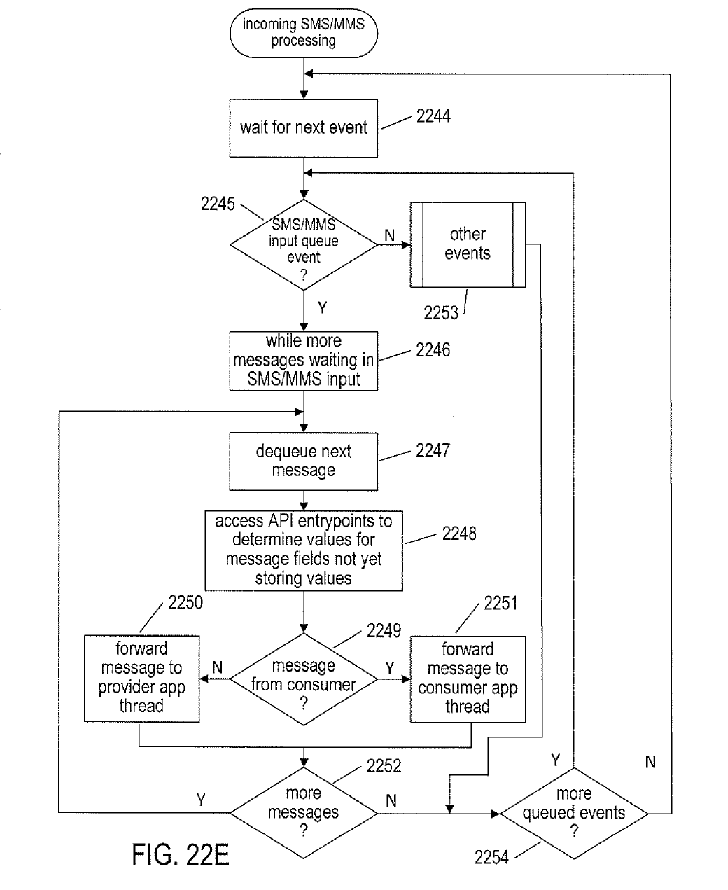

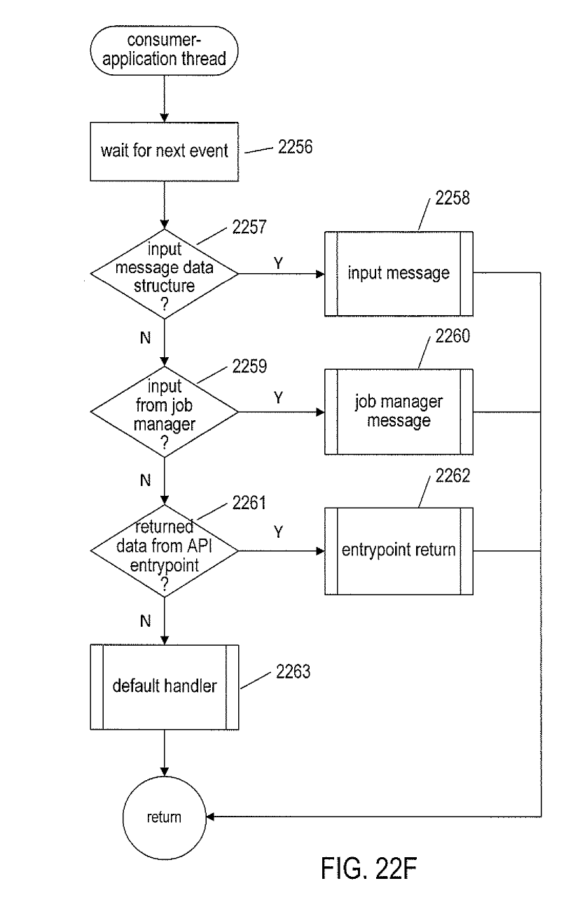

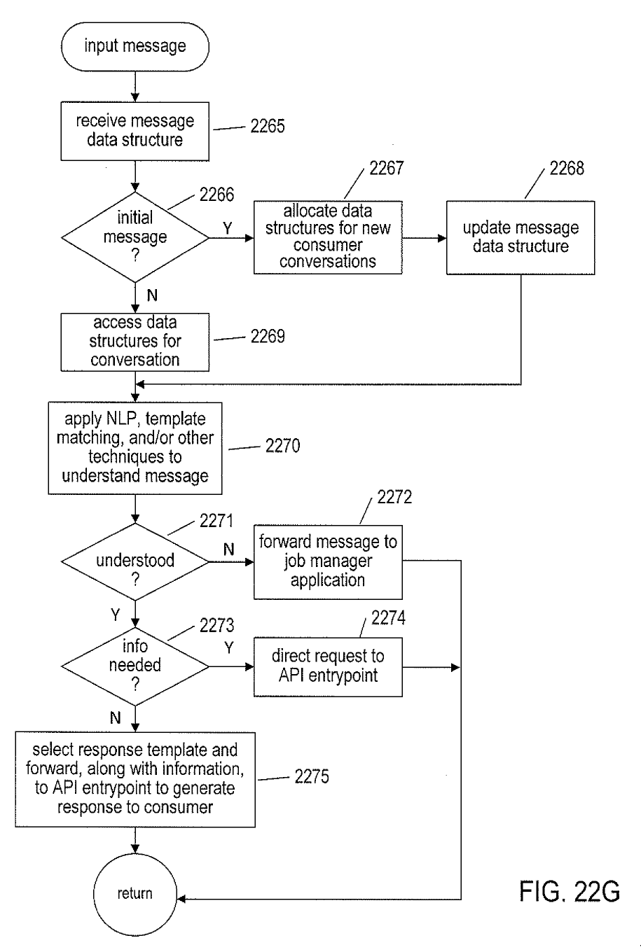

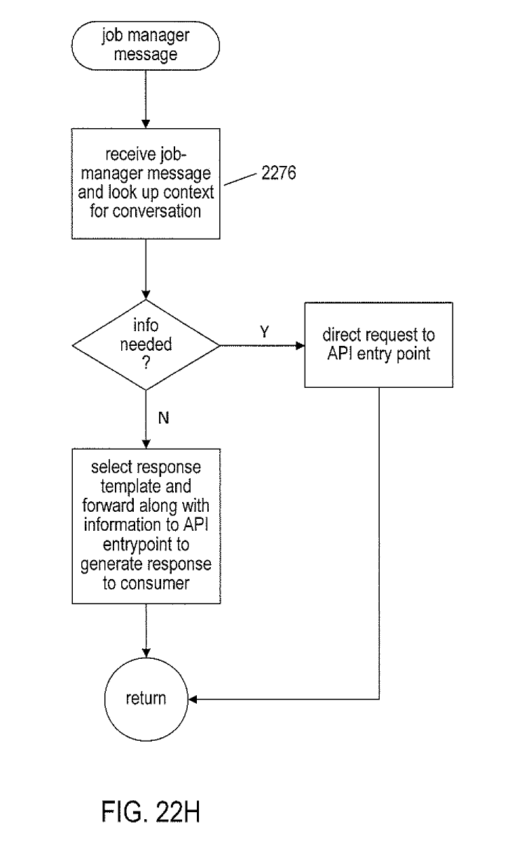

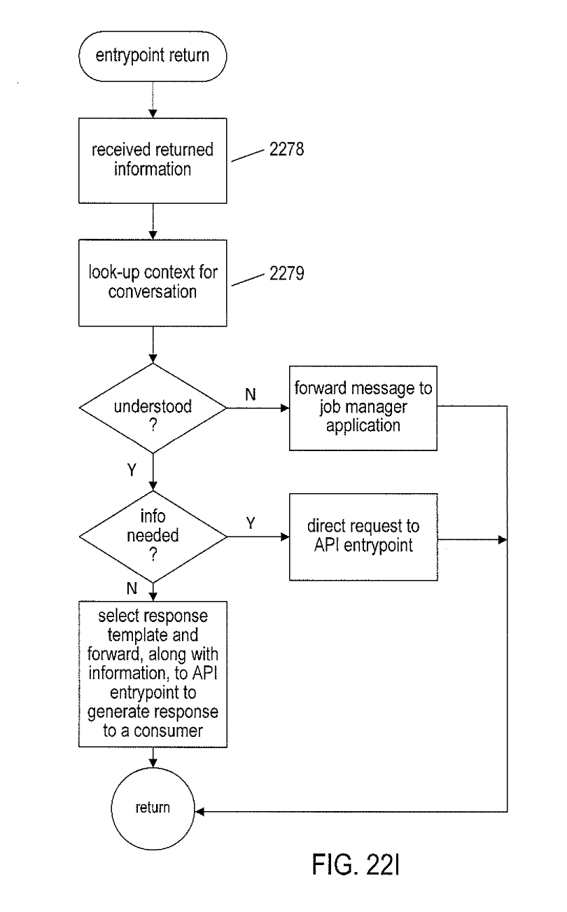

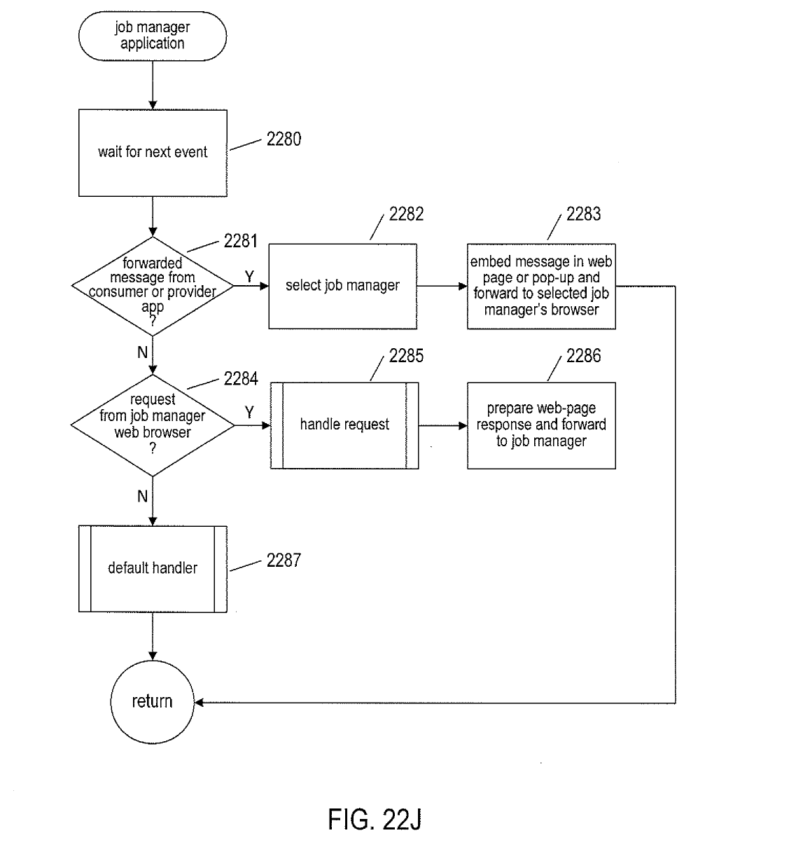

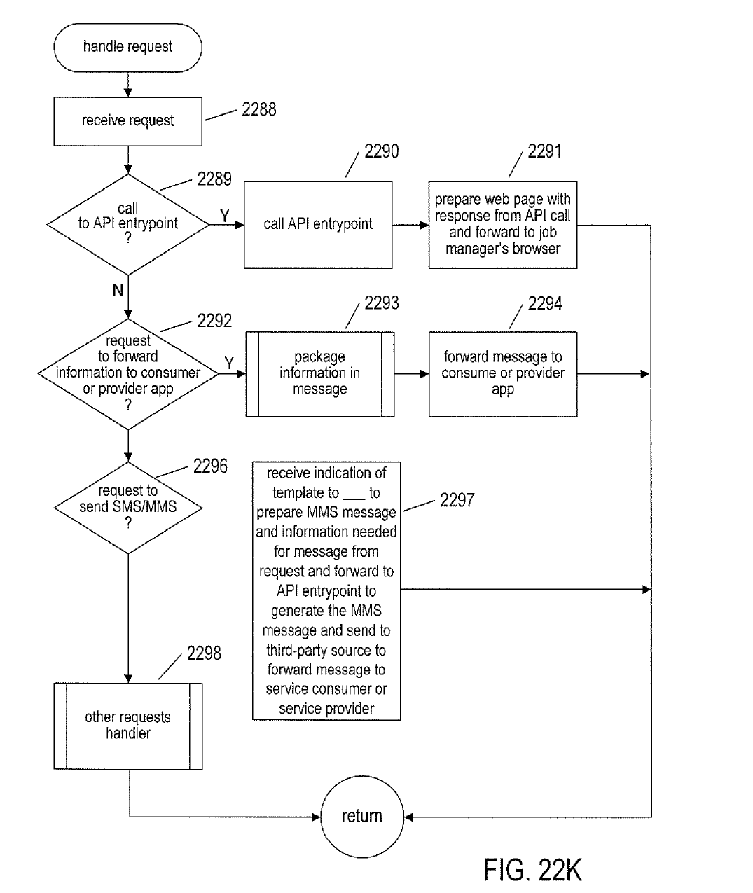

FIGS. 22A-K illustrate one implementation of SMS-and-MMS-based communications within the ASB. FIG. 22A shows a revised architectural diagram, similar to the architectural diagram shown in FIG. 7, that includes SMS-and-MSM-based communications support facilities within the ASB. The additional support facilities include an SMS/MMS interface 2202, consumer SMS/MMS applications 2203, provider SMS/MMS applications 2204, job-manager applications 2205, and an additional set of API-endpoint application servers 2206 for SMS/MMS-specific functionality. The additional API-endpoint-application servers 2206 may access functionality provided by the previously discussed API-endpoint application servers 2208 and provide functionality to the various applications, including the job-manager applications 2205, the SMS/MMS consumer applications 2203, and the SMS/MMS provider applications 2204, as indicated by the dashed lines 2209 in FIG. 22A. As discussed above, multiple virtual servers are generally instantiated to logically represent each endpoint. Load-balancing functionality is employed for distributing workload among the multiple servers of each service and interface. Internal communications, in many implementations, employ RESTful protocols based on JavaScript Object Notation (“JSON”) over the hypertext transfer protocol (“HTTP”). Each of the services is generally associated with stored information. In many implementations, the stored information is stored in various virtual mass-storage appliances for access by the service-providing services.

FIG. 22B illustrates communications pathways and computational entities involved in SMS-and-MMS-based communications within the ASB. There are many different possible implementations that involve different types of computational entities and communications topologies. The communications pathways and computational entities shown in FIG. 22B are used as an example to facilitate additional discussions, below. However, particular circular queues and application threads shown in FIG. 22B may not be used in all implementations and are provided in FIG. 22B to show logical data-flow interconnections between computation components.

Arrow 2210 represents incoming SMS and MMS messages from various communications interfaces within the ASB. The ASB may contract with third-party communications companies to receive SMS and MMS messages or may receive the SMS and MMS messages directly from mobile carriers, the public switch telephone network (“PSTN”), or wide-area networks, including the Internet. The received SMS and MMS messages are received through one or more SMS-and-MMS-messaging interfaces by an initial incoming SMS/MMS processing module, not shown explicitly in FIG. 22B, and transformed into corresponding message data structures that are input to an SMS/MMS input queue 2211. In FIG. 22B, the various input and output queues are shown as circular queues, frequently used in messaging applications as the data-transfer mechanism between asynchronous processes. A typical message data structure is shown in inset 2212. The message data structure 2213 generally include fields that contain a telephone number 2214, a conversation identifier 2215, a sequence number 2216, a user identifier 2217, and a sender type 2218, and the actual received SMS or MMS message 2219. In alternative implementations, fewer, more, and/or different fields may be included in a message data structure. In certain implementations, alternative types of stored data are used to represent received SMS/MMS messages. The message data structures are dequeued from the SMS/MMS input queue 2211 for consumption by threads within SMS/MMS consumer applications 2220 and SMS/MMS provider applications 2221, in certain implementations. The consumer-application threads and provider-application threads may themselves dequeue messages from the SMS/MMS input queue, in certain implementations, or, in other implementations, a separate input-processing module may dequeue data message structures from the SMS/MMS input queue and forward the data structures to appropriate consumer-application and provider-application threads. In general, a thread is devoted to a particular conversation, or session, that represents an interaction between a service consumer and the ASB or a service provider and the ASB. The SMS/MMS consumer applications and SMS/MMS provider applications, in processing received SMS/MMS messages, may generate requests to job-manager applications or API entry points, which are queued to circular queue 2223. Job-manager application threads receive the requests from circular queue 2223, either directly dequeuing the requests from circular queue 2223 or receiving requests forwarded by a module that monitors the output queue 2223, dequeues requests, and forwards the requests to appropriate job-manager-application threads and API-entrypoint-application servers. Responses from job-manager threads 2224 and API-entrypoint-application-server threads 2225 may be queued to an additional circular queue 2226 from which they are received by requesting consumer-application 2220 and provider-application 2221 threads. Again, in many implementations, circular queues 2223 and 2226 are not used, but, instead, messages are directly forwarded or various types of queues and buffers store messages for particular handlers or threads. In certain cases, API-entrypoint-application-server threads generate and transmit SMS or MMS messages that are returned to consumers and providers, as represented by arrow 2227 in FIG. 22B, to consumers and providers from which SMS or MMS requests were received. In general, the content for SMS and MMS response messages are forwarded to a third-party messaging system for transmission to service consumers and service providers communicating with the ASB via SMS- and/or -MMS communications.

FIGS. 22C-K provide control-flow diagrams that illustrate operation of the various computational entities discussed above with reference to FIG. 22B. FIG. 22C provides a control-flow diagram for an incoming SMS/MMS processing module that receives SMS and MMS messages and queues corresponding message data structures to input queue 2211. In step 2229, the routine waits for a next event to occur. When the next-occurring event is an SMS/MMS input event, as determined in step 2230, then, in step 2231, a processing routine is called to generate a message data structure corresponding to the received SMS/MMS message and, in step 2232, queue the message data structure to the SMS/MMS input queue (221 in FIG. 22B). Ellipses 2233-2234 indicate that various other events may be handled by the incoming SMS/MMS routine. A default event handler 2234 may handle rare and unexpected events. When there are more events queued for handling, as determined in step 2236, control returns to step 2230. Otherwise, control returns to step 2229 to wait for a next event. This same event-handling-loop logic is used repeatedly in subsequent control-flow diagrams, discussed below.

FIG. 22D provides a control-flow diagram for the routine that processes incoming SMS/MMS messages called in step 2231 in FIG. 22C. In step 2238, an SMS or MMS message is received. In step 2239, the routine allocates a data structure for the message. In step 2240, the routine enters a telephone number and message content into the message data structure based on the message in the received SMS or MMS message. In step 2241, the routine enters values for any of the other fields in the message data structure that the routine can determine. For example, in certain implementations, the routine may be able to match the telephone number to a table of current conversations in order to obtain the conversation identifier corresponding to the message, in the case that the message is a second or subsequent message received from a service consumer or service provider during the course of a conversation or information transaction. Finally, in step 2242, the routine queues the message data structure to the SMS/MMS input queue (2211 in FIG. 22).

FIG. 22E provides a control-flow diagram for a module that monitors the SMS/MMS input queue (2211 in FIG. 22B) for new message data structures and dispatches the message data structures to appropriate consumer-application and provider-application threads. In step 2224, the routine waits for a next event to occur, when the next-occurring event is an SMS/MMS input-queue event, as determined in step 2245, then, in the while-loop of steps 2246-2252, the routine processes as many message data structures queued to the SMS/MMS input queue (2211 in FIG. 22B) as possible. Other types of events are processed in step 2253. The message data structures dequeued to the SMS/MMS input queue are processed by dequeuing each next message data structure, in step 2247, and then, in step 2248, accessing one or more API entry points to determine values for the fields of the message data structure not yet storing values. For example, API entry points can be used to determine a sequence number for the message corresponding to the message data structure, a user ID for the service consumer or service provider who sent the message, and a sender type indicating whether the message was sent by a service consumer or service provider. The API entry point may initialize an internal conversation data structure and generate a new conversation identifier when the received message is the first message received from a particular individual within some period of time. When the message data structure represents a message received from a service consumer, as determined in step 2249, then the message data structure is forwarded to an appropriate consumer application thread in step 2251. Otherwise, the message data structure is forwarded to an appropriate provider-application thread in step 2250. When there are more messages queued to the SMS/MMS input queue, as determined in step 2252, control returns to step 2247. Otherwise, when there are more events queued for processing, as determined in step 2254, control returns to step 2245. Otherwise, control returns to step 2244, where the routine waits for a next event to occur.

FIG. 22F provides a control-flow diagram for a consumer-application thread. Because provider-application threads include similar functionality, separate control-flow diagrams for provider-application threads are omitted, for the sake of brevity. In step 2256, the consumer-application thread waits for a next event to occur. When the next-occurring event is input of a message data structure to the consumer-application thread, as determined in step 2257, then, in step 2258, an input-message routine is called to process the message data structure. Otherwise, when the event represents input of a response to a request from a job-manager application thread, as determined in step 2259, a job-manager-message routine is called in step 2260. Otherwise, when the event corresponds to reception of data returned by an API entrypoint previously called by the consumer-application thread, as determined in step 2261, then, in step 2262, an entrypoint-return routine is called. A default handler 2263 handles any rare or unexpected events.

FIG. 22G provides a control-flow diagram for the input-message routine called in step 2258 of FIG. 22F. In step 2265, the message data structure is received by the input-message routine. When the message data structure represents an initial message of a conversation, as determined in step 2266, then, in step 2267, the input-message routine allocates data structures for a new consumer conversation and, in step 2268, accordingly updates the message data structure. Otherwise, in step 2269, the input-message routine accesses data structures for the conversation to which the message corresponding to the message data structure belongs. In step 2270, the input-message routine applies natural language processing (“NLP”), template matching, rule-based analysis, state-transition models, and/or other technologies to attempt to understand the message corresponding to the message data structure in the context of the particular conversation to which the message corresponding to the message data structure belongs. For example, had the ASB requested, from a service consumer or service provider, particular information, then, in step 2270, the input-message routine attempts to determine, from the contents stored in the message data structure, whether the requested information has been provided by the service consumer or service provider. When the message is not understood within the context of the conservation to which the message belongs, as determined in step 2271, then, in step 2272, the input-message routine forwards the message to a job-manager-application thread for processing. Otherwise, when the input-message routine needs to obtain additional information in order to process the message, as determined in step 2273, then, in step 2274, the input-message routine directs a request to an API-entry point application server for the needed information. Otherwise, in step 2275, the input-message routine selects a response template and forwards the response template, along with information needed to generate an MMS response to the message represented by the message data structure, to an API-entrypoint server which then generates an MMS response or SMS response to return to the consumer. Thus, step 2275 represents those cases in which the ASB can automatically respond to received SMS or MMS messages. Those cases in which human intervention is needed are represented by step 2272. Note that the service-consumer application can access API entrypoints, in step 2274, to obtain information needed to process a received SMS or MMS message from a service consumer. The template-based generation of response messages allows either a job manager or automated ASB message-processing functionalities to generate and return personalized, service-consumer-specific and service-provider-specific response messages. The information supplied along with a temple to the API-entrypoint server may be tailored specifically to a particular individual in the context of a particular conversation, which greatly increases the effectiveness and efficiency of the conversation-based information exchanges. Note that these personalized responses are real-time responses, so that communications with the ASB have to feel of, and generate emotional responses similar to, human conversations and dialogues.

FIG. 22H provides a control-flow diagram for the job-manager-message routine called in step 2260 of FIG. 22F. This routine handles messages returned to the consumer-application thread by the job manager via circular queue 2226 in FIG. 22B. In step 2276, the routine receives a job-manager message and looks up the context, or conversation-related data, for the conversation with respect to which the job-manager message was generated. In general, the job-manager message provides sufficient information for the consumer-application thread to continue processing an SMS or MMS message received from a service consumer. In certain cases, intervention by the job manager, as a result of forwarding a service-consumer message to the job manager in step 2272 of FIG. 22G, can place the consumer-application thread back into a position to automatically process the service-consumer message and automatically generate a reply. The remaining steps in FIG. 22H are identical to steps 2273-2275 in FIG. 22G.

FIG. 22I provides a control-flow diagram for the entrypoint-return routine called in step 2262 of FIG. 22F. This routine processes data returned by an API entrypoint to the consumer-application thread following a call to the API entrypoint in step 2274 of FIG. 22G. In step 2278, the entrypoint-return routine receives the information returned from the call to the API entrypoint and, in step 2279, looks up the context for the conversation with respect to which the consumer-application thread initially called the API entrypoint in step 2274 of FIG. 22G. After processing the returned information, the consumer-application thread may generally be in a better position to continue processing a service-consumer message and generate an automated reply. Thus, the remaining steps in FIG. 22I are identical to steps 2271-2275 in FIG. 22G, representing continued processing, by the consumer-application thread, of a service-consumer message using the information returned by the API entrypoint.

FIG. 22J shows a control-flow diagram for a job-manager application thread. In step 2280, the job-manager-application thread waits for a next event to occur. When the next-occurring event is reception of a message forwarded from a service-consumer application or service-provider application, as determined in step 2281, then, in step 2282, the job-manager-application thread selects a human job manager to which to forward the message and, in step 2283, embeds the message in a web page or browser pop-up window and forwards the web page of pop-up to the selected job manager's browser. In many cases, the job-manager-application thread attempts to forward messages related to a particular conversation to the same job manager. When the next-occurring event is a request from a job manager's web browser, as determined in step 2284, then, in step 2285, a request handler is called and, in step 2286, data returned by the request-handler routine is packaged into a web page response and forwarded to the job manager's web browser. A default handler 2287 handles rare or unexpected events.

FIG. 22K provides a flow-control diagram for the handle-request routine called in step 2285 of FIG. 22J. In step 2288, the handler-request routine receives a new request that was directed to a job-manager-application thread by a job manager's browser. When the request is a request to call an API entrypoint, as determined in step 2289, then the entrypoint is called in step 2290 and a response web page is prepared and forwarded to the job manager's browser, in step 2291, to return data returned by the API entrypoint to the job manager. When the request is a request to forward information to a service-consumer or service-provider application thread, as determined in 2292, then the information is packaged into a message, in step 2293, and the message is forwarded, in step 2294, to the service-consumer or service-provider application thread. When the request is a request to send an SMS or MMS message to a service consumer or service provider, as determined in step 2296, then, in step 2297, an indication of a template for the SMS or MMS message is extracted from the request and provided, along with any information needed to generate the MMS message, to an API entrypoint to generate the MMS message from the template and forward the generated message to a third-party SMS/MMS message sender. Other types of requests are processed by a default request handler 2298.

To summarize the SMS/MMS-communications facilities within the ASB, the ASB includes service-provider and service-consumer applications that attempt to process received SMS and MSM message automatically in order to match service providers with service consumers and facilitate service transactions between service providers and service consumers. In addition, the ABS can act as a communications intermediary to facilitate direct communications between a service consumer and a service provider. The ASB may forward service-consumer messages to a service provider on behalf of the service consumer and can then forward responses to those messages from the service provider to the service consumer. Similarly, the ABS may forward messages from a service provider to a service consumer and return response messages from the service consumer to the service provider. Additionally, the ABS may support broadcast type messages that, as one example, allow a service provider to send an informational message to all or a portion of the service provider's current service-consumer customers. The service-consumer and service-provider applications access internal API entrypoints that, in turn, may access additional API entrypoints common to ASB operation in order to identify and understand the types of services being requested, find appropriate service providers to provide the service, schedule service provision, and carry out all the other activities discussed above. However, because of the open-nature of SMS and MMS communications, in many cases, particularly during initial information exchanges between a service consumer and the ASB, fully automated processing of SMS and MMS messages may not be possible, in which case the messages are forwarded to a human job manager to assist in the processing of the messages. In some cases, the human job manager may return information to the service-consumer or service-provider application that will enable the service-provider and service-consumer applications to continue automated processing. In other cases, the job manager may end up composing response SMS and MMS messages for transmission to service consumers and service providers. It should be noted that, in general, service consumers and service providers transmit SMS messages, initially, to the ASB at the beginning of a conversation or information transaction. In general, the ASB responds with MMS messages that contain graphical information cards that are displayed to service consumers and service providers on their smart phone in the context of threaded SMS/MMS messages. However, in the case that a user's device cannot receive MMS messages, the ASB returns SMS text messages. It should also be noted that the communications architecture, described above, allows service consumers and service providers to respond to ASB messages and requests using either SMS/MMS messaging or web-browser responses. Because the ASB identifies users and user devices, a particular conversation or information transaction may be carried out by a user using multiple devices. In fact, the ASB may also support direct voice-based information exchanges between service consumers, service providers, and the ASB via human job managers that communicate through the communications console via VOIP protocols. In essence, the ASB can accommodate any type of common communications methodologies using a combination of service-consumer and service-provider applications and job managers interacting with service consumers and service providers as well as with the computational facilities within the ASB via the communications console provided by the ASB to job managers.

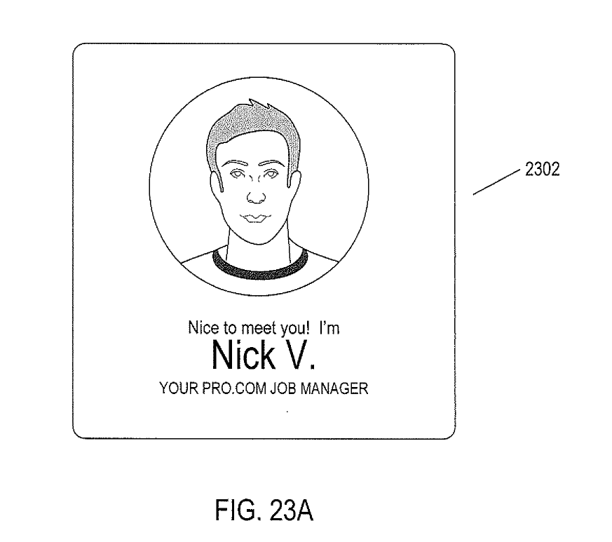

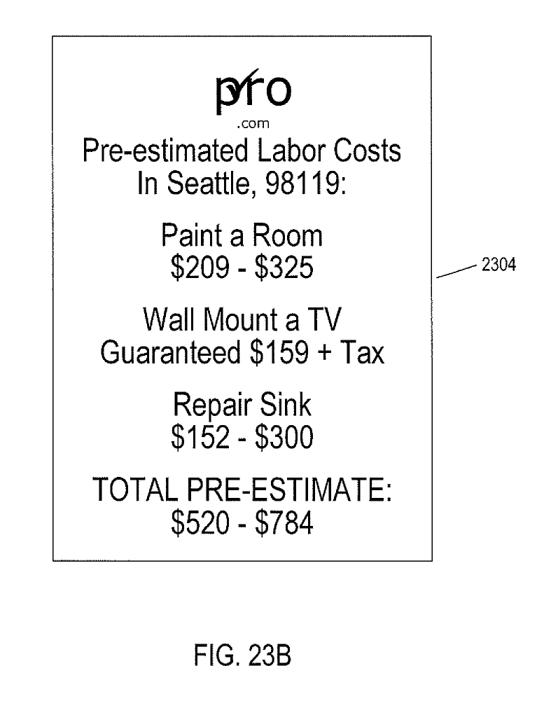

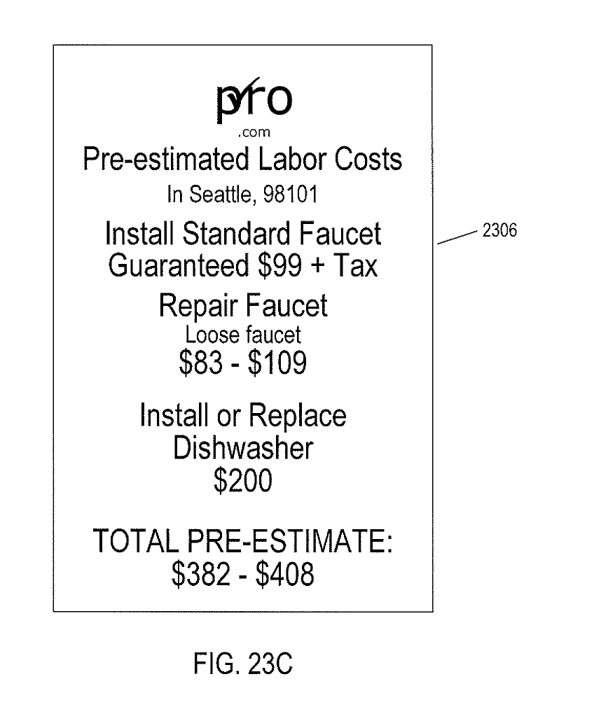

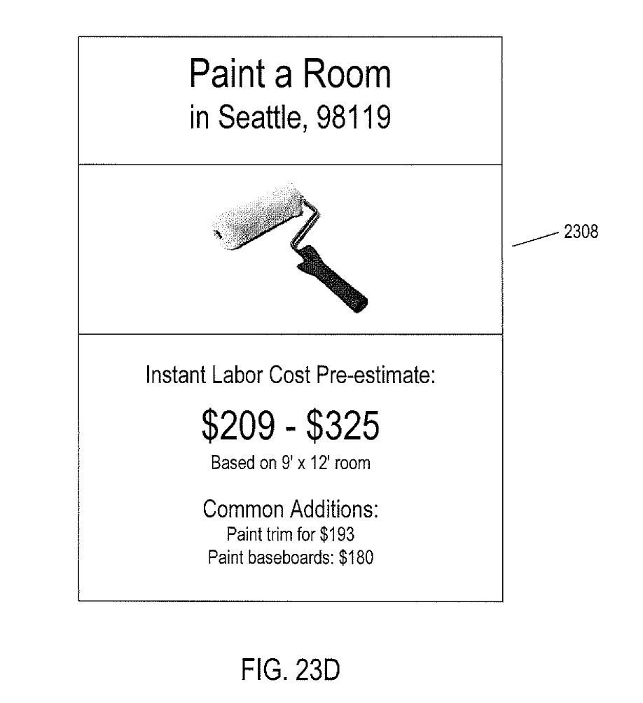

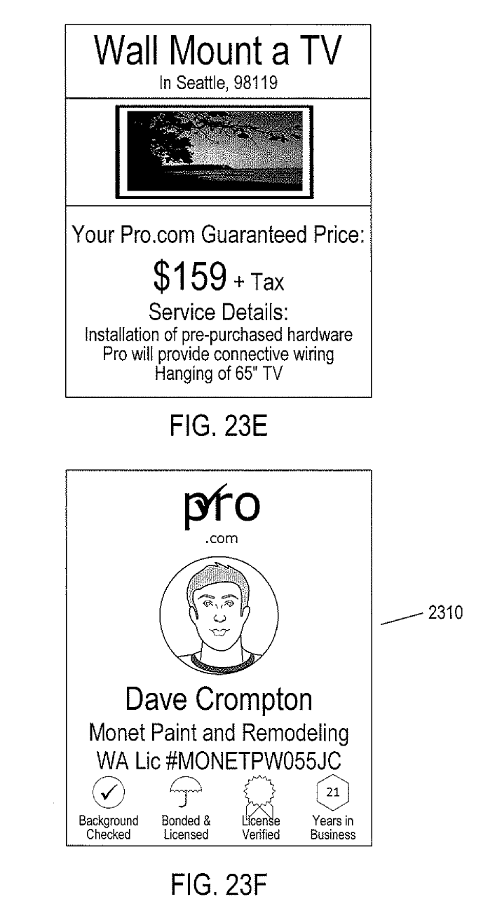

FIGS. 23A-F illustrate a variety of the different MMS graphical cards that may be returned to service consumers and service providers by the ASB during information transactions and conversations conducted by the ASB with service consumers and service providers via SMS and MMS messaging. FIG. 23A shows an example MMS card that is returned, in one implementation, by an ASB as a first response to a service-consumer or service-provider SMS or MMS message that initiates a conversation or information exchange with the ASB. As discussed above, the MMS card 2302 is generated from an MMS card template and specific information, including the job-manager's name, that is combined with the template to generate the MMS card, on the fly, by the ASB. FIG. 23B shows an MMS card that includes a price pre-estimate that is returned to a service consumer during an SMS/MMS-based conversation. The pre-estimate MMS card 2304 includes initial estimates of various services requested by a service consumer. FIG. 23C shows a pre-estimate MMS card that includes a guaranteed price. The pre-estimate MMS card 2306 includes a guaranteed price of $99 for installation of a faucet. This example illustrates that, by generating MMS cards on the fly, the ASB can extract information from a variety of databases, using a variety of internal applications and API entrypoints, to provide a flexible and precise information exchange with SMS/MMS messaging, just as with web-page and web-browser communications. FIG. 23D shows a project list item MMS card. The project-list-item MMS card 2308 provides additional details about an estimated service provision. FIG. 23E shows another project-list-item MMS that includes a guaranteed price. FIG. 23F shows a service-provider-introduction MMS card. The service-provider-introduction MMS card 2310 shows a picture of the service provider, the service provider's name, and information about the service provider's credentials and licenses. The various MMS cards shown in FIGS. 23A-F represent a few examples of the many different types of MMS cards that are generated by the ASB, on the fly, during SMS/MMS-based communications with service consumers and service providers.

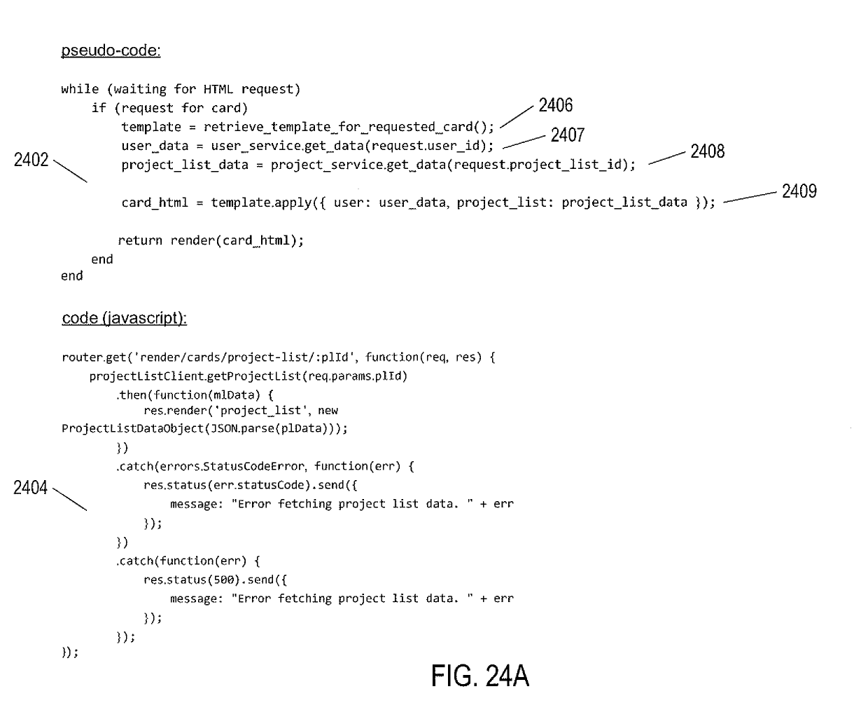

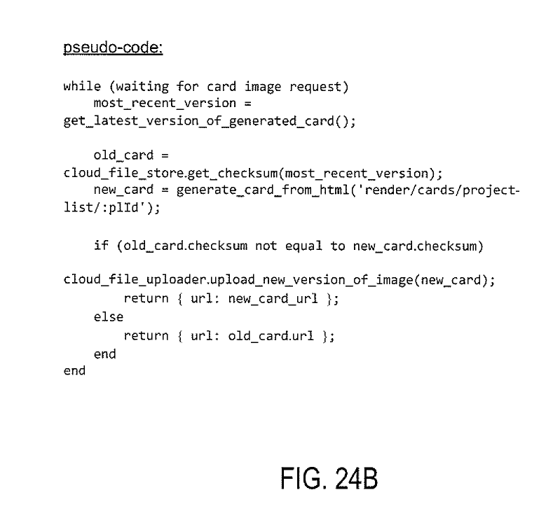

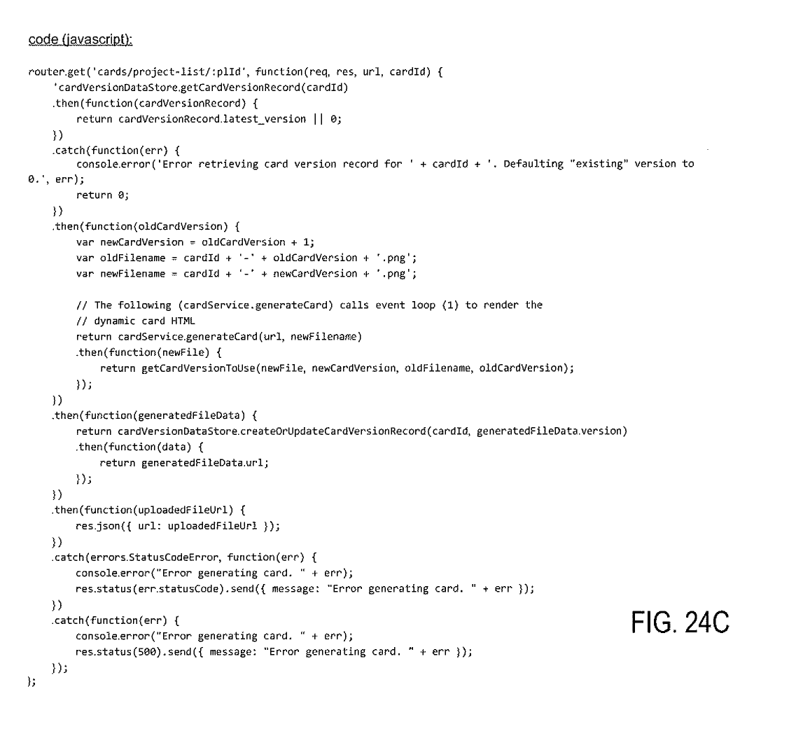

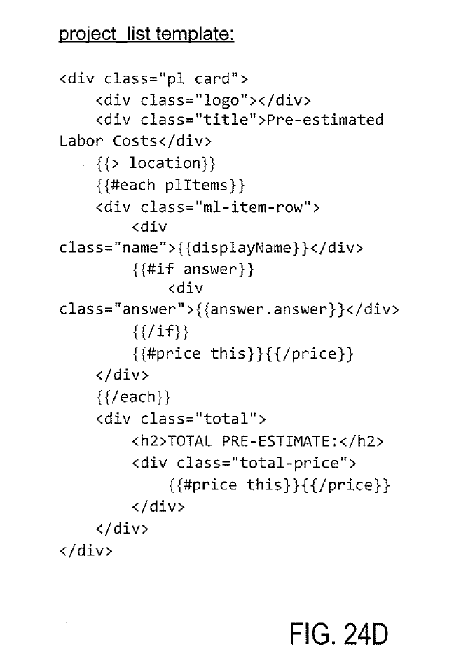

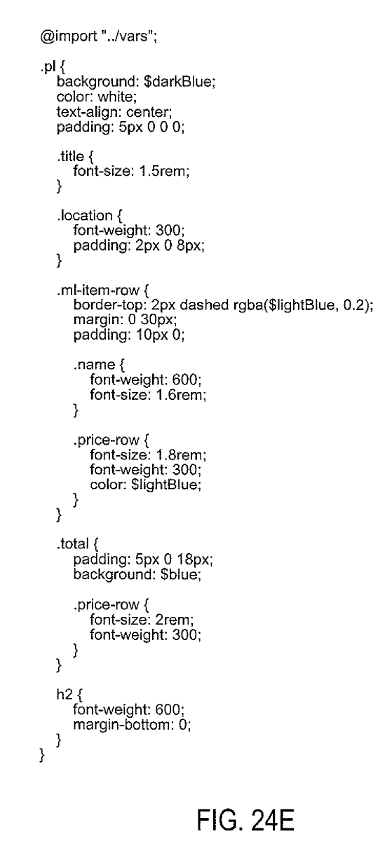

FIGS. 24A-E provide pseudocode and corresponding JavaScript code to illustrate certain features and aspects of the MMS-card-generation process that is used, within the ASB, to generate MMS cards on the fly. The MMS-card-generation system and process can generate highly personalized MMS cards based on the service transaction, consumer inputs and provider profile and inputs. FIG. 24A shows an event loop for an MMS-card-generating service that receives HTML requests for MMS cards and generates an MMS card in response to those requests. A pseudocode version of the event loop is first shown in FIG. 24A, 2402, followed by a JavaScript version of the event loop 2404. In the ASB implementation that employs the MMS-card-generating service, the service continuously runs within the ASB to receive MMS-card requests and generate MMS cards in response to those requests. MMS card generation involves accessing a template 2406, accessing user data to be included in the MMS card 2407, accessing additional project information 2408, and inserting the user data and additional information into the template in order to generate an HTML representation of the MMS card 2409. Styling configuration is applied to the card using cascading style sheets (“CSS”) style sheet representations. The HTML representation of the card, along with the CSS-specified styling configuration is then rendered to produce a graphic or image that is uploaded to a cloud file store, from where the image or graphic can be accessed via a public URL. A third-party SMS/MMS messaging service can, for example, access the image using the public URL in order to transmit the MMS card to a service consumer or service provider.

FIG. 24B shows pseudocode, and FIG. 24C shows corresponding JavaScript, for a cloud file store service that uploads newly generated MMS cards. Checking is done so that if the newly generated MMS card is identical to a previously generated and stored MMS card, the new MMS card is not stored, but, instead, the URL for the identical, already generated and stored card is returned. FIG. 24D provides an example of a template for an MMS card. FIG. 24E shows an example CSS style-sheet description of the style configuration for the MMS card template shown in FIG. 24D.

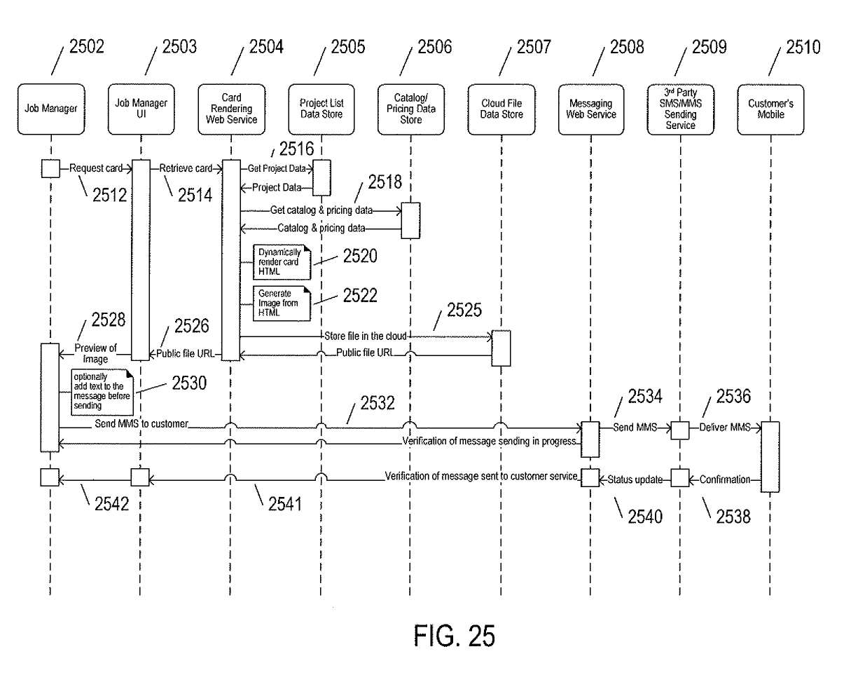

FIG. 25 shows a time-series diagram that illustrates data flow within one implementation of an ASB involved in sending, by a job manager, a project-list MMS card to a service consumer. In the ASB implementation to which the time-series diagram is related, various internal components of the ASB are involved in generating and transmitting the project-list MMS card to a service consumer. These include the job manager, a job-manager web-based user interface, a card-rendering web service, discussed above with reference to FIGS. 24A-E, a project-list data store that contains lists of services, including SKUs and pricing information, a catalog/pricing data store that is a central repository for SKUs and pricing data, a cloud file data store in which MMS card images are stored for retrieval via public URLs, as discussed above with reference to FIGS. 24A-E, a messaging web service that manages communications between job managers, customers, and providers, and a third-party SMS/MMS messaging service that sends SMS and MMS messages to remote users. These entities are represented by labeled rectangles 2502-2509 at the top of FIG. 25. The service-consumer's mobile device is represented by an additional rectangle 2510. In the implementation to which the time-series diagram is related to, the job manager requests an MMS card via the job manager user interface 2512, and the job manager user interface retrieves a template for the card and forwards the template 2514 to the card rendering web service. The card-rendering web service accesses project data 2516 from the project-list data store and obtains catalog and pricing data from the catalog/pricing data store 2518. The card-rendering web service then dynamically renders the card in HTML and generates a graphical image from the HTML description 2520 and 2522, respectively. Then, the card-rendering web service transmits the image to the cloud-file data store for storage and receives, in response, the public URL for the image 2524. The URL is returned to the job manager user interface 2526 which displays a preview of the image to the job manager 2528. The job manager may elect to edit the MMS card 2530 via the job manager user interface. Thus, this example illustrates a general feature of the ABS that permits job managers to review and edit response messages before they are returned to a service consumer or service provider. This provides for human conversational subtleties and refinements that complement the fact-and-context driven responses generated by the ABS. Finally, the job manager requests transmission of the card to the service consumer 2532 from the messaging web service which then transmits the image and address information 2534 to the third-party SMS/MMS messaging service. The third-party SMS/MMS messaging service then delivers the image as an MMS message 2536 to the service consumer's mobile device. The mobile device returns a confirmation of receiving the MMS message 2538, which is ultimately returned to the job manager 2540-2542. Thus, FIG. 25 provides additional details with respect to a particular implementation of the ASB more broadly described above with reference to FIGS. 21A-22K.

Although the present invention has been described in terms of particular embodiments, it is not intended that the invention be limited to these embodiments. Modifications within the spirit of the invention will be apparent to those skilled in the art. For example, any of many different implementations for the service-provider matching method incorporated within an automated system can be obtained by varying any of many different implementation and design parameters, including selection of program language or languages, data-storage methods, hardware platforms, operating systems, virtualization layers, control structures, data structures, modular organization, and many other such design and implementation parameters. The matching score produced in the above-described implementation considers numerous different characteristics associated with service providers to select a set of candidate service providers and associate each candidate service provider with a score. In alternative implementations, additional, fewer, and different characteristics and considerations may be employed to select candidate service providers and compute match scores for the candidate service providers. In certain implementations, the criteria used to identify candidate service providers may be relaxed, if an initial search for service providers fails. In these implementations, the automated system may attempt to find multiple service providers that, together, can provide the needed services corresponding to a project list. Many different types of implementations of SMS/MMS messaging are possible, with internal communications among entities carried out by RESTful communications or by other types of request/response communications. Different implementations may use different internal computational entities and services. Text-based, image-based, and text-and-image-based messaging other than SMS/MMS may be used instead of, or in addition to, SMS/MMS messaging.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A distributed automated system that identifies candidate service providers on behalf of service consumers, the distributed automated system comprising:
multiple virtual servers and data-storage appliances of a virtual data center within a cloud-computing facility, the multiple virtual servers and data-storage appliances implemented within multiple physical computers, each including at least one processor and memory that stores computer instructions executed by the at least one processor, and physical data-storage devices; and
computer instructions, stored in one or more physical memories of one or more of the physical computers within the cloud-computing facility, that, when executed by one or more processors of the one or more of the physical computers within the cloud-computing facility, control the virtual data center to exchange one or both of short-message-service and multimedia-message-service messages with a user's processor-controlled electronic device within the context of a conversation, the conversation comprising one of
a service request made by a service-consumer user of the distributed automated system, in response to which the distributed automated system provides cost estimates and identifies candidate service providers for the service-consumer user, from among which the service-consumer user selects a service provider and schedules service provision,
a service-provision offer made by the distributed automated system on behalf of a service-consumer user to a service-provider user, which the service-provider user may accept or decline.

2. The distributed automated system of claim 1 wherein the distributed automated system receives one or both of short-message-service and multimedia-message-service messages from users through one or more external message services, for each received message
when the message responds to a message previously sent by the distributed automated system to a user, identifying a conversation with which the message is associated and stored data that represents the conversation;
when the message is a first message of a new conversation, initializing stored data for a new conversation to which the message is assigned; and
dispatches the message to an application thread for processing.

3. The distributed automated system of claim 2 wherein the stored data that represents a conversation includes:
a conversation identifier;
a user identifier;
a conversation-type indication; and
an indication of the current state of the conversation.

4. The distributed automated system of claim 2 wherein the application thread is one of a service-consumer-application thread that processes messages received from service consumers and a service-provider application that processes messages received from service providers.

5. The distributed automated system of claim 2 wherein, when an application thread receives a message dispatched to the application thread for processing, the application thread
applies one or more computational processing methodologies to the message to determine what information the message contains and an appropriate response message to return to a user device.

6. The distributed automated system of claim 5 where in the one or more computational processing methodologies are selected from among:
natural language processing;
template matching;
application of a state-transition model; and
rule-based analysis.

7. The distributed automated system of claim 5 wherein
when the application thread succeeds in determining an appropriate response message to return to a user device, selecting a response-message template and accessing additional stored information to provide the response-message template and additional information that the application thread forwards to a multimedia-message-service card-generation service to generate a multimedia-message-service card that is returned to the user device in a multimedia-message-service message.

8. The distributed automated system of claim 7 wherein the multimedia-message-service card-generation service uses the template, an associated style configuration, and the additional information the generate an encoding of the multimedia-message-service card that the multimedia-message-service card-generation service renders into an image.

9. The distributed automated system of claim 8 wherein the multimedia-message-service card-generation service stores the image rendered from the encoding of the multimedia-message-service card in a publicly accessible data-storage facility from which the image can be retrieved using a universal resource locater corresponding to the image.

10. The distributed automated system of claim 9 wherein the application directs a third-party multimedia-message-service messaging service to access the image stored in the publicly accessible data-storage facility and transmit the image to the user device.

11. The distributed automated system of claim 5 wherein the application threads accesses an internal information service or application-programming-interface entrypoint to obtain additional information needed to determine an appropriate response message to return to a user device.

12. The distributed automated system of claim 5 wherein
when the application thread fails to determine an appropriate response message to return to a user device, that application thread forwards the message to a job-manager application thread.

13. The distributed automated system of claim 12 wherein the job-manager thread packages the message in a web page or browser pop-up and displays the web page or browser pop-up on a communications console for review by a human job manager.

14. The distributed automated system of claim 13 wherein the job manager, following review of the message packaged in the web page or browser pop-up displayed on the communications console, accesses, through the communications console, distributed-automated-system services or entrypoints to obtain additional information to facilitate review of the message.

15. The distributed automated system of claim 13 wherein the job manager, following review of the message packaged in the web page or browser pop-up displayed on the communications console, returns information to the application thread to allow the application thread to prepare and send a response to the message to the user device.

16. The distributed automated system of claim 13 wherein the job manager, following review of the message packaged in the web page or browser pop-up displayed on the communications console, interacts with the communications console to select a response-message template and access additional stored information to provide the response-message template and additional information that the communications console forwards to a multimedia-message-service card-generation service to generate a multimedia-message-service card that is returned to the user device in a multimedia-message-service message

17. The distributed automated system of claim 1 wherein each conversation comprises a series of request messages and response messages and the response messages sent by the distributed automated system to distributed-automated-system users are multimedia-message-service messages that contain a multimedia-message-service card.

18. The distributed automated system of claim 17 wherein a multimedia-message-service card is an image generated from a hypertext-markup-language-encoded multimedia-message-service card.

19. The distributed automated system of claim 18 wherein the hypertext-markup-language-encoded multimedia-message-service card is generated by the distributed automated system during processing of a message received from a user from a template, a style configuration, and additional information stored within the distributed automated system.

20. The distributed automated system of claim 17 wherein the image is stored in a publicly accessible data store and retrieved for sending in a multimedia-message-service message using a universal resource locator.
